(19) United States
(12) Patent Application Publication
(10) Pub. No.: US 2003/0049407 A1
(43) Pub. Date: Mar. 13, 2003

(54) Disposable cleaning sheets comprising a plurality of protrusions for removing debris from surfaces

(75) Inventors: Mark Leslie Kacher, Mason, OH (US); Michael Stephen Maile, Maineville, OH (US); Andrea Pfarr Switzer, Maineville, OH (US); Arthur Wong, West Chester, OH (US); Laura Krebs Brown, Brussels (BE); Preston James Rhamy, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/161,445

(22) Filed: Jun. 3, 2002

Related U.S. Application Data
(60) Provisional application No. 60/300,700, filed on Jun. 25, 2001.
(60) Provisional application No. 60/370,712, filed on Apr. 8, 2002.

(51) Int. Cl. B32B 3/06; A47L 13/18; B43L 21/00; B32B 15/04; D04H 1/56; A47K 7/02; B32B 7/12; A47L 13/46; A47L 25/00

(52) U.S. Cl. 428/100; 15/208; 15/209.1; 15/231; 15/227; 15/228; 134/6; 428/99; 442/409; 442/400; 442/401; 428/343

(57) ABSTRACT

Disposable cleaning sheets for removing debris from a surface comprise a substrate and a plurality of protrusions affixed to the substrate, wherein the cleaning sheet is removably attachable to a cleaning implement. The protrusions are preferably hook-shaped. The preferred hook-shaped protrusions can be made of certain thermoplastic resins and can have certain geometric configurations. The protrusions can be affixed to the substrate via a variety of process and are preferably affixed to the substrate in one or more zones of the substrate. Methods of removing debris from a surface comprise contacting the surface with a cleaning sheet of the present invention.

### CROSS REFERENCE TO RELATED APPLICATIONS

This application claims priority under 35 U.S.C. §119(e) to U.S. Provisional Application Serial No. 60/300,700, filed Jun. 25, 2001 (Attorney Docket No. 8604P); and U.S. Provisional Application Serial No. 60/370,712, filed Apr. 8, 2002 (Attorney Docket No. 8604P2).

### TECHNICAL FIELD

The present invention relates to cleaning sheets comprising protrusions for removing debris, such as human hair, pet hair, dirt, dust, and the like, from soft surfaces, such as carpeting, upholstery, and the like.

### BACKGROUND OF THE INVENTION

It is often difficult to remove unwanted debris from surfaces, especially from soft surfaces. For example, it is difficult to remove pet hair from carpeting. Conventional vacuum cleaners often do not do a sufficient job in removing pet hair from carpeting. Even though vacuum cleaners are capable of removing some pet hair from carpeting, it can be inconvenient to repeatedly use a vacuum cleaner because of its weight and power requirements. In addition, pet hair can become entangled in the roller brush of the vacuum cleaner requiring either cleaning or repair of the vacuum.

A number of devices have been disclosed to address the problem of removing debris from soft surfaces. For example, U.S. Pat. No. 4,703,538 issued to Silverstrone discloses a cleaning tool suited for picking up dirt, lint, and the like from rugs, floors, upholstered furniture and other surfaces. The cleaning tool of Silverstrone consists of an elongated handle having a pair of legs extending outwardly to engage a cylindrically shaped cleaning element having an external surface made of Velcro. Discs are fitted between the ends of the cylinder and the legs of the handle to fixedly mount the cylinder to the legs of the handle. The cleaning tool can then be pushed over the surface to be cleaned to pick up dirt, lint, and the like. However, this cleaning tool is inconvenient in that the consumer must manually clean the cylinder cleaning element after the cleaning element accumulates dirt, lint, and the like. Since the cylinder is fixedly mounted to the legs of the handle, the cleaning tool must be manually cleaned every time debris accumulates in the Velcro.

A tool for removing animal hair from carpeting is disclosed in U.S. Pat. No. 4,042,995 issued to Varon. The tool of Varon contains a field of smooth tapered polyethylene bristles extending down from a head attached to a broom handle. The density of the bristles at the trailing edge is greater than elsewhere and the bristles are arranged in a saw-tooth leading edge pattern. As the tool is pulled through carpeting, the bristles pick up animal hair. The bristles are permanently attached to the head of the broom handle. As with the cleaning tool of Silverstrone, the tool of Varon suffers from the problem of having to manually clean out the bristles of the tool every time the bristles accumulate debris.

A device for removing fiber pills and lint from fabrics is disclosed in U.S. Pat. No. 5,036,561 issued to Calafut. The device of Calafut contains a supporting substrate, such as a pliant foam sheet, that has on one surface an abrasive coating of substantially uniform particles having 280-600 grit size for removing pills from fabrics and has on its other surface a fabric with slant, hook, or loop pile to remove lint from fabrics. The device is sized to fit in one's pocket or purse. The abrasive side of device is rubbed against the fabric to remove pills. The lint removing side of the device is a pile fabric having free ends disposed in a common angular direction and demonstrates relatively good gripping and holding ability of lint when drawn in one direction and then readily releases the lint when drawn in the opposite direction. One issue which is apparently not addressed in Calafut, is that some types of hooks can potentially damage certain types of soft surfaces. Calafut does not make any distinction between the different types of hooks which can be used on a soft surface. In particular, Calafut does not disclose hooks which can provide both lint removal and surface safety. In addition, it has been observed that a soft surface, such as for example a carpet, can typically comprise a greater volume of hair as opposed to lint. As a result, efficient hair removal and lint removal can be viewed as two different problems. Another potential issue with the Calafut device is that it is apparently not intended to be disposable. Consequently, a user is required to clean out the lint removing side each time it is saturated with lint in order to be able to reuse this device.

Other types of cleaning devices comprising an adhesive roller such as the one described in U.S. Pat. No. 6,014,788 issued to Jaffri, U.S. Pat. No. 5,878,034 issued to Cox et al. and U.S. Publication No. US20020023666A1 to Tawara et al., are known in the art to remove debris from carpets, upholstery and other types of fabric. However, the adhesive surface of these rollers is quickly covered with dust, rendering the “poisoned” surface covered with adhesive ineffective for extended cleaning, without requiring a frequent replacement of the adhesive surface.

It has thus been desired to create a cleaning sheet that can remove debris, such as pet hair, from surfaces, such as soft surfaces, which can be conveniently disposed by the consumer after use. As a result, the cleaning sheet does not have to be manually cleaned out after each use, but instead is easily disposed of after use.

### SUMMARY OF THE INVENTION

The present invention relates to disposable cleaning sheets or mitts for removing debris, especially hair, from a surface, especially soft surfaces such as carpeting or upholstery. The cleaning sheets comprise a substrate and a plurality of protrusions affixed to the substrate. The protrusions are preferably selected from the group consisting of hooks, slanted fibers, bristles, and combinations thereof. In a preferred embodiment, the cleaning sheets are removably attachable to a cleaning implement.

The present invention provides a convenient way for a consumer to remove debris from surfaces, especially soft surfaces such as carpet, where it is often difficult to remove debris such as hair, in particular pet hair. The protrusions of the present cleaning sheets or mitts are able to effectively dislodge the debris from the surface being cleaned, and have the ability to retain the removed debris in the cleaning sheet. Therefore, a consumer can simply wipe the surface with the present cleaning sheet or mitt and conveniently dispose of it after cleaning the surface, thus throwing away the debris along with the cleaning sheet or mitt. The cleaning sheets or mitts herein thus do not require to be cleaned themselves and are easily disposed of.

The present invention further relates to methods of removing debris from a surface by contacting the surface with a cleaning sheet or mitt of the present invention. The surfaces cleaned by the present methods are preferably soft surfaces, such as carpet.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### BRIEF DESCRIPTION OF THE DRAWINGS

FIG. 1 is a top view of a disposable cleaning sheet of the present invention comprising two discrete zones of protrusions, each zone containing a plurality of protrusions.

FIG. 2 is a cross-section of the disposable cleaning sheet of FIG. 1 along X-X′.

FIG. 3 is a top view of a disposable cleaning sheet of the present invention comprising two discrete zones of protrusions, each zone containing a plurality of protrusions and polymeric additive material disposed in a checkerboard pattern.

FIG. 4 is a cross-section of the disposable cleaning sheet of FIG. 3 along X-X′.

FIG. 5 is a top view of a disposable cleaning sheet of the present invention comprising six discrete zones of protrusions, each zone containing a plurality of protrusions, and adhesive material disposed between the discrete zones of protrusions.

FIG. 6 is a cross-section of the disposable cleaning sheet of FIG. 5 along X-X′.

FIG. 7 is a side elevational view of a protrusion that is a J-type hook.

FIG. 8 is a side elevational view of a protrusion that is a Prong-type hook.

FIG. 9 is a side elevational view of a protrusion that is a Mushroom-type hook.

FIG. 10 is a side elevational view of a protrusion that is a Banana-type hook.

FIG. 11 is a side elevational view of a protrusion that is a Y-type hook.

FIG. 12 is a side elevational view of a protrusion that is a Multi-tipped-type hook.

FIG. 13 is a front elevational view of a protrusion that is a J-type hook.

FIG. 14 is a top view of a disposable cleaning sheet of the present invention comprising two discrete zones of protrusions, each zone containing a plurality of protrusions, each linear discrete zone being angled relative to the side edges of the sheet.

FIG. 15 is a top view of a disposable cleaning sheet of the present invention comprising two discrete zones of protrusions, each zone containing a plurality of protrusions being angled relative to the side edges of the sheet.

FIG. 16 is a side elevational view of a protrusion which does not have a plane of symetry.

FIG. 17 is a front elevational view of a protrusion which does not have a plane of symetry.

FIG. 18 is a cross-section of the disposable cleaning sheet of one embodiment of the invention.

FIG. 19 is a cross-section of the disposable cleaning sheet of one embodiment of the invention.

FIG. 20 is a cross-section of the disposable cleaning sheet of one embodiment of the invention.

FIG. 21 is a perspective view of a mop head of a cleaning implement with a cleaning sheet of the present invention attached thereto.

FIG. 22 is a top view of a disposable cleaning mitt of the present invention comprising six discrete zones of protrusions, each zone containing a plurality of protrusions.

FIG. 23 is a top view of a reusable cleaning meet of the present invention comprising a fastening material.

FIG. 24 is a top view of a disposable cleaning sheet of the present invention, for use with the reusable cleaning mitt of FIG. 23 comprising five discrete zones of protrusions, each zone containing a plurality of protrusions.

FIG. 25 is a cross-section of the disposable cleaning sheet of FIG. 24 along X-X′.

### DETAILED DESCRIPTION OF THE INVENTION

### I. DISPOSABLE CLEANING SHEETS

The disposable cleaning sheets of the present invention comprise a substrate and a plurality of protrusions, preferably hooks, affixed to the substrate. In a preferred embodiment of the invention, the cleaning sheet is removably attachable to a cleaning implement. The cleaning sheets of the present invention are especially useful in removing debris and soils that are typically difficult to remove from soft surfaces, such as carpet or upholstery. Pet hair and human hair are particularly difficult to remove from soft surfaces such as carpeting. It is often difficult, even for powered vacuum cleaners, to remove such debris. The cleaning sheets of the present invention, however, are particularly effective in removing such debris from soft surfaces and are conveniently disposable after use. Thus the cleaning sheet can be simply thrown away after use, along with all of the debris and soil collected in the cleaning sheet.

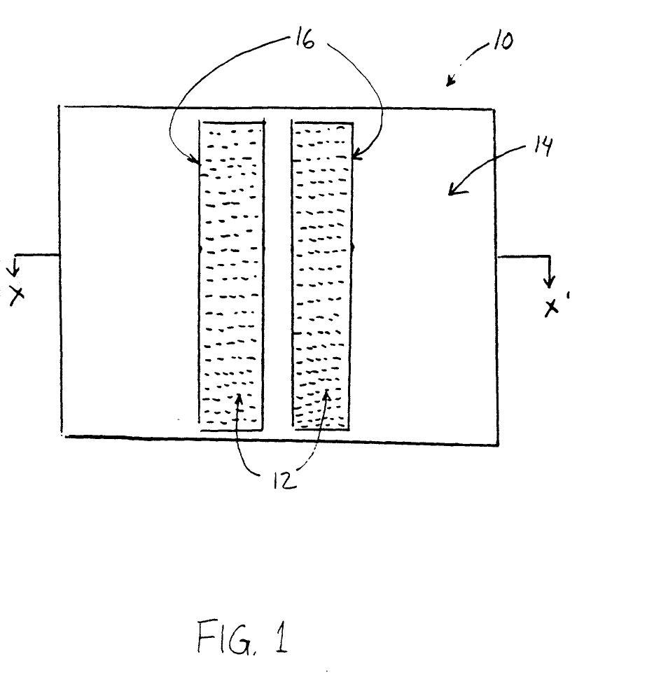

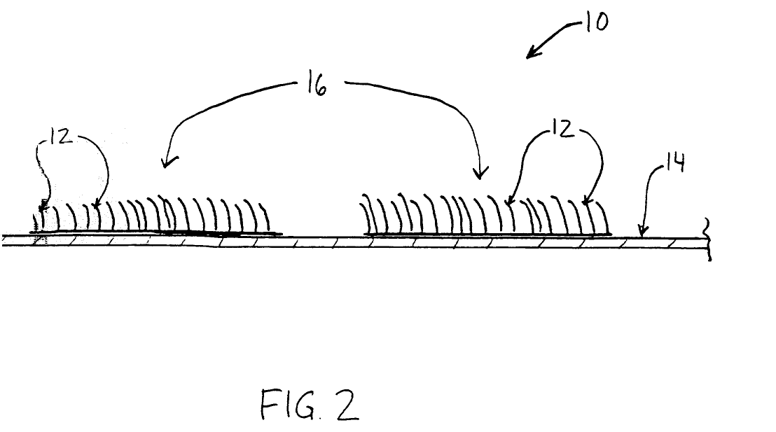

Preferred embodiments of disposable cleaning sheets of the present invention are shown in FIGS. 1, 3 and 5. Cross-section views of the cleaning sheets of FIGS. 1, 3 and 5, which illustrate the protrusions affixed to the substrate of the present cleaning sheets, are shown in FIGS. 2, 4 and 6, respectively.

A. SUBSTRATES

The substrates useful in the present cleaning sheets include a wide variety of different types of substrates. The substrates can be woven or nonwoven and can be made of synthetic, natural, or hybrid fibers. The substrates can also be a polymeric film. The substrates can be made from a variety of processes including, but not limited to, hydroentanged, spunbonded, meltblown, carded, and the like. Preferably the substrates are nonwoven and made of synthetic fibers from a hydroentangling, meltblown or spunbonded process. The substrates can also be laminates of spunbond and meltblown layers.

The substrates of the cleaning sheets of the present invention can be made using either a woven or nonwoven process, or by forming operations using melted materials laid down on forms, especially in belts, and/or by forming operations involving mechanical actions/modifications carried out on films. The structures are made by any number of methods (e.g., spunbonded, meltblown, resin bonded, air-through bonded, etc.). Preferred substrates include nonwoven substrates selected from the group consisting of spunbonded substrates, meltblown substrates, hydroentangled substrates, thermoplastic film substrates, airlaid substrates, carded substrates, and combinations thereof.

Materials particularly suitable for forming the preferred nonwoven substrates of the present cleaning sheets include, for example, natural cellulosics as well as synthetics such as polyolefins (e.g., polyethylene and polypropylene), polyesters, polyamides, synthetic cellulosics (e.g., RAYON®), and blends thereof. Also useful are natural fibers, such as cotton or blends thereof and those derived from various cellulosic sources. Preferred starting materials for making the substrates of the present cleaning sheets are synthetic materials, which may be in the form of carded, spunbonded, meltblown, airlaid, or other structures. Particularly preferred are polyesters, especially carded polyester fibers, polypropylene fibers, and polyethylene fibers. The resistance to abrasion and tearing of the substrate as the cleaning sheet is rubbed across the surface, e.g. carpet, upholstery, or other fabric surface, can be an important factor in selected the form of the substrate and the fiber composition. The degree of hydrophobicity or hydrophilicity of the fibers is further optimized depending upon the desired goal of the sheet, either in terms of type of soil to be removed, the type of additive that is provided, when an additive is present, biodegradability, availability, and combinations of such considerations. In general, the more biodegradable materials are hydrophilic, but the more effective materials tend to be hydrophobic.

The substrates can be formed from a single fibrous layer or can be a laminate of two or more separate layers. Preferably, the sheets are nonwovens made via a hydroentangling or spunbonded process. In this regard, prior to hydroentangling discrete layers of fibers, it may be desired to slightly entangle each of the layers prior to joining the layers by entanglement.

To enhance the integrity of the substrate, a polymeric net (referred to herein as a “scrim” material) can be incorporated in the substrate, such that the scrim material is arranged with the fibrous material, e.g., though lamination via heat or chemical means such as adhesives, or via hydrogentanglement. Scrim materials useful herein are described in detail in U.S. Pat. No. 4,636,419. The scrims may be formed directly at the extrusion die or can be derived from extruded films by fibrillation or by embossment, followed by stretching and splitting. The scrim may be derived from a polyolefin such as polyethylene or polypropylene, copolymers thereof, poly(butylene terephthalate), polyethylene terephthalate, Nylon 6, Nylon 66, and the like. Scrim materials are available from various commercial sources. A preferred scrim material useful in the present invention is a polypropylene scrim, available from Conwed Plastics (Minneapolis, Minn.).

The substrates of the present cleaning sheets will typically have a basis weight of from about 15 to about 195 g/m², preferably from about 20 to about 90 g/m², and more preferably from about 30 to about 80 g/m². The substrate can comprise one or more fiber layers. Each fiber layer can be of the same construction or can be of different construction.

Preferred substrates herein include a carded, thermal bonded fibrous web having a basis weight of 70 g/m² comprised of 80% of polypropylene fibers and 20% of rayon fibers. Another preferred substrate is a trilayer laminate comprising two outer spunbond layers and an inner meltblown layer with a baisi weight of 48 g/m2, and comprises 100% polypropylene. Both preferred substrates are commercially available from BBA Nonwovens (Simpsonville, S.C. USA). Other suitable substrates are described in detail in U.S. application Ser. No. 09/082,349 filed May 20, 1998; U.S. application Ser. No. 09/082,396 filed May 20, 1998; and U.S. application Ser. No. 09/729,626 filed Nov. 30, 2000.

One skilled in the art will understand that in the event a disposable cleaning sheet is used with a cleaning implement comprising grippers, such as the ones later described, the substrate will be sized such that at least a portion of the substrate is removably “grippable” by the grippers.

B. PROTRUSIONS

The cleaning sheets of the present invention further comprise a plurality of protrusions affixed to the substrate described herein. The protrusions of the present cleaning sheets enhance the pick-up of particulate materials, especially animal hair or human hair, from surfaces, especially soft surfaces such as carpeting, upholstery, and the like. In a preferred embodiment, the protrusions are chosen such that they do not snag or get caught by the fibers of the surface.

The protrusions can be of a variety of shapes including, but not limited to, hooks, slanted fibers, bristles, and the like. The plurality of protrusions affixed to the substrate can be all of a uniform shape or can be a combination of different shapes. Preferably at least some of the protrusions are hook-shaped protrusions. Preferred hook-shaped protrusions include a variety of types, including, for example, “J-type” hooks, “Prong-type” hooks, “Mushroom-type” hooks, “Banana-type” hooks, “Y-type” hooks, “Multi-tipped” hooks and the like.

The protrusions incorporated into the present cleaning sheets can be made of a variety of materials. For example, the protrusions can be formed from materials including, but not limited to, polymers, polymeric resins, and the like, preferably thermoplastic resins. The thermoplastic resins preferably comprise a thermoplastic polymer and can preferably further comprise tackifying resins, plasticizers, and other optional ingredients such as diluents, stabilizers, antioxidants, colorants, and fillers. Suitable tackifying resins and plasticizers are described in co-pending U.S. application Ser. No. 09/821,953 filed Mar. 30, 2001 by Kacher et al.

A preferred material from which to form protrusions of the present cleaning sheets are thermoplastic resins. The thermoplastic resins herein will typically have a softening temperature of from about 45° C. to about 260° C., more preferably from about 80° C. to about 200° C., and even more preferably from about 90° C. to about 180° C. “Softening temperature” of a thermoplastic resin can be measured according to a standard method, ASTM D1525.

Preferred thermoplastic resins comprise thermoplastic polymer selected from the group consisting of: styrene copolymer blends, wherein the copolymer is selected from the group consisting of butadiene, acrylonitrile, divinylbenzene, maleic anhydride; block copolymers containing polystyrene endblocks and polyisoprene, polybutadiene, and/or polyethylene-butylene midblocks; polyolefins such as polyethylene, polypropylene, amorphous polypropylene, polyisoprene, and polyethylene propylene; ethylene-vinylacetate copolymers; acrylonitrile-butadiene copolymers; polyesters such as polyethylene terphthalate; polyamides such as Nylon 6 and Nylon 11; polyisobutylene; poly(vinyl ethylene-co-1,4-butadiene); natural rubber [poly cis-isoprene]; polyacrylic acid and salts thereof; polymethacrylic acid and salts thereof; polydimethylsiloxane; polydiphenylsiloxane; poly methyl phenyl siloxane; polyvinyl alcohol; polyvinyl chloride; polyvinylidene chloride; polyurethane; and mixtures thereof.

Preferably, the thermoplastic resins used to form protrusions have a certain degree of elasticity. The degree of elasticity is related to Young's modulus, which is the ratio of the tensile stress to the extension strain of a given material. The value of Young's modulus indicates the resistance of a material to reversible longitudinal deformation. Simplistically, it can be considered as the theoretical stress or force required to double the length of a specimen. The Handbook of Common Polymers-Fibres, Films. Plastics. and Rubber, complied by W. J. Roff et al. (1971), lists the Young's modulus for a number of materials. Young's modulus can be measured using a standard method known as ASTM D797. Typical values for Young's modulus for thermoplastic resins/polymers at 20° C. to 25° C. of the present invention, when said resin/polymer is in the form of filaments, threads, or wires, and where the relative humidity is 65% when the humidity can impact the results, are shown in the following table:

Young's Modulus of Common Thermoplastic Resin/Polymer Fibers

| Resin/Polymer | kN/m² (×10⁻⁴) |
|---|---|
| Rubber (Vulcanized, soft; thread) | 0.15 |
| Polyurethane (elasteromeric | 1.0 |
| thread) | |
| Polyethylene (low density) | 79 |
| Polyvinylidene Chloride | 100-150 |
| Nylon 6 | 200-290 |
| Cellulose Acetate | 290-440 |
| Polyvinyl Alcohol | 200-1180 |
| Polypropylene (monofilament) | 320 |
| Polyacrylnitrile | 390-690 |
| Polyester (Terylene) | 390-1470 |
| Polyethylene (high density) | 390 |
| Polyvinyl chloride | 490 |
| Nylon 11 | 490 |
| Viscose Rayon | 590-880 |
| Polypropylene (continuous | 640 |
| filament yarn) | |

The preferred protrusions of the present cleaning sheets are formed of a material having a Young's modulus of from about 1 to about 1500 kN/m² (×10⁻⁴), preferably from about 50 to about 1000 kN/m² (×10⁻⁴), and more preferably from about 75 to about 750 kN/m² (×10⁻⁴).

Thermoplastic resins preferred herein for forming protrusions of the present cleaning sheets include polyethylene (which can be low density, high density and/or cross linked), polypropylene (monofilament or continuous filament), and mixtures thereof.

In general, the protrusions will be affixed to the substrates such that the protrusions cover from about 5% to about 100%, preferably from about 10% to about 70%, and more preferably from about 15% to about 60% of the surface area of at least one outer surface of the substrate. The protrusions can be affixed to only one outer surface of the substrate of the cleaning sheet but the protrusions can also be affixed to both outer surfaces. One skilled in the art will understand that a cleaning sheet comprising protrusions in only one of its outer surfaces, can be attached to the mop head of a cleaning implement such that the outer surface of the substrate that is free of protrusions is oriented against the bottom surface of the mop head, while the other outer surface to which the protrusions are affixed will be available to contact the surface to be cleaned.

In one embodiment, the protrusions can be affixed to the substrate such that when the cleaning sheet is attached to a mop head, the portion of the cleaning sheet covering the edge(s) and/or the top of the mop head will comprise some protrusions. This embodiment might be particularly useful to remove debris from a vertical surface.

The protrusions are typically affixed to the substrate herein in rows of protrusions. The protrusions will generally be positioned such that the distance between two consecutive protrusions in a given row will be at least 0.15 mm, from about 0.2 to about 10 mm, preferably from about 0.2 to about 5 mm, preferably from about 0.3 to about 5 mm, more preferably from about 0.6 to about 3 mm, even more preferably from about 0.8 to about 3 mm, and most preferably from about 0.9 to about 2 mm. The number of protrusions per square centimeter will typically be from about 1 to about 1000, preferably from about 10 to about 100, and more preferably from about 20 to about 50. In one embodiment, two or more protrusions can share a common base and then flare outwards to become separated.

As discussed hereinbefore, the protrusions of the present cleaning sheets can be a variety of shapes. For example, the protrusions can be slanted fibers. The slanted fibers preferably have a sufficient Young's modulus to provide enough resiliency (e.g. low elasticity) to the slanted fibers to enable the slanted fibers to dislodge debris from the surface being cleaned. Slanted fibers are straight protrusions that extend from the substrate at an acute angle, with respect to the substrate.

The protrusions can also include bristles, which are similar to slanted fibers, except that they extend perpendicularly straight out from the substrate, forming a 90° angle with the substrate.

Preferred protrusions herein, however, are hook-shaped protrusions. Hook-shaped protrusions can themselves come in a variety of shapes. Preferred hook-shaped protrusions include, for example, “J-type” hooks, “Prong-type” hooks, “Mushroom-type” hooks, “Banana-type” hooks, “Y-type” hooks, “Multi-tipped” hooks and the like, as described hereinafter.

The present cleaning sheets comprise a plurality of protrusions, which can all be of the same shape or can be a combination of protrusions having two or more different shapes. It is also possible to have a plurality of protrusions which are all facing towards the same direction or which are pointing towards different directions. The shapes and resiliency of the protrusions are preferably selected based on the surface desired to be cleaned, especially soft surfaces such as carpet, upholstery, and the like. In order to yield the best of debris removal and easy movement of the cleaning sheet across the surface, the shape and resiliency of the protrusions can also be selected based on the type of carpet or upholstery being cleaned. For example, more aggressive hooks (e.g. less elasticity and/or more curl in the engagement end of the hook) can be used on plush carpet, while less aggressive hooks (e.g. more elasticity and/or less curl in the engagement end of the hook) are preferred for loop-type carpet, such as berber carpet. Typically, the thinner the protrusions and the greater the distance between individual protrusions, the less aggressive the resulting cleaning sheet will be.

When the present cleaning sheets are contacted to the surface to be cleaned, preferably by moving or wiping the cleaning sheet across the surface, the protrusions of the present cleaning sheets are capable of dislodging debris from the surface, removing the debris from the surface, and retaining the debris on the cleaning sheet. Since the debris is retained in the cleaning sheet, once the user is finished cleaning the surface, the user can simply dispose of the cleaning sheet, along with the debris retained by the cleaning sheet.

Hook-shaped protrusions are especially effective at removing hair, particularly animal pet hair, from soft surfaces such as carpet.

### Preferred Hook-Shaped Protrusions

As discussed herein, it is preferred that at least some of the protrusions of the present disposable cleaning sheets are hook-shaped protrusions. Hook-shaped protrusions generally comprise a base, a stem, an engagement end and can either be symmetrical or asymmetrical relative to a plane perpendicular to the protrusion's base. The base of the protrusion secures the hook-shaped protrusion to the substrate and can connect the individual hooks to one another. The engagement end of the protrusion helps to dislodge and retain debris from the surface being cleaned. The engagement end of a hook-shaped protrusion can be especially useful for dislodging and retaining hair, including pet hair, from carpeting.

Hook shapes preferred herein include, but are not limited to, J-type hooks, Prong-type hooks, Mushroom-type hooks, Banana-type hooks, Y-type hooks, Multi-tipped hooks and the like. Non-limiting examples of hook-shaped protrusions suitable herein are shown in FIGS. 7 to 10.

Preferred hook shapes can be selected based upon parameters, defined hereinafter, such as: Total Height (mm); Slope (degree); Tip Diameter (mm); Curl (degree); Length (mm); Front Stem Width; Side Stem Width at ⅓ Height (mm); Ratio of Side Stem Width at ⅔ Height (mm) to Side Stem Width at ⅓ Height (mm); Ratio of Vertical Hook Gap (mm) to Total Height (mm); Horizontal Hook Opening (mm); and Vertical Hook Opening (mm). Preferred hook shapes can be selected with these certain parameters based on the type of surface desired to be cleaned with the present cleaning sheets.

Preferred hook-shaped protrusions of the present cleaning sheets exhibit one or more of the following parameters:

(a) a Total Height of from about 0.5 to about 80 mm, preferably from about 0.25 to about 6.0 mm, and more preferably from about 1.5 to about 3 mm;

(b) a Slope of from about 15 to about 90, preferably from about 40 to about 90, and more preferably from about 75 to about 85;

(c) a Tip Diameter of from about 0.002 to about 10 mm, preferably from about 0.01 to about 1.0 mm, and more preferably from about 0.03 to about 0.5 mm;

(d) a Curl of from about 0 to about 630, preferably from about 1 to about 180, and more preferably from about 75 to about 160;

(e) a Front Stem Width of at least about 0.05 mm, preferably from about 0.1 to about 1 mm, more preferably from about 0.15 to about 0.3 mm and most preferably from about 0.2 to about 0.3 mm;

(f) a Side Stem Width at ⅓ Height of from about 0.02 to about 5 mm, preferably from about 0.05 to about 2.5 mm, and more preferably from about 0.1 to about 0.25 mm;

(g) a ratio of Side Stem Width at ⅔ Height (mm) to Side Stem Width at ⅓ Height (mm) of from about 2:5 to about 1:1, preferably from about 1:2 to about 0.95:1, and more preferably from about 3:5 to about 0.9:1;

(h) a Length of from about 0.001 to about 25 mm, preferably from about 0.01 to about 10 mm, and more preferably from about 0.8 to about 4 mm;

(i) a ratio of Vertical Hook Opening to Total Height of from about 1:20 to about 1:1, preferably from about 2:5 to about 1:1, and more preferably from about 4:5 to about 1:1;

(j) a Horizontal Hook Opening of from about 0.05 to about 0.2 mm, preferably from about 0.07 to about 1.2 mm, and more preferably from about 0.1 to about 0.5 mm; and/or

(k) a Vertical Hook Opening of from about 0.05 to about 0.2 mm, preferably from about 0.07 to about 1.2 mm, and more preferably from about 0.1 to about 0.5 mm.

The preferred hook-shaped protrusions herein will have a variety of combinations of such parameters, depending upon the surface to be cleaned.

### J-type Hooks

FIG. 7 is a side elevational view of a J-type hook 70 that is suitable as a protrusion for the present disposable cleaning sheets. Referring to FIG. 7, a preferred J-type hook 70 generally has a base 71, a stem 72 and an engagement end 73. The base 71 of the J-type hook 70 is affixed to the substrate 74. At the end of the engagement end 73 is a tip 75. The apex 76 of the J-type hook 70 is the point furthest away from the base 71, perpendicularly. The Total Height 77 of the J-type hook 70 is measured in millimeters as the perpendicular distance between the apex 76 and the base 71.

The Side Stem Width at ⅓ Height 78 is measured as the side horizontal width of the stem 72, as shown in FIG. 7, at a perpendicular distance from the base 71 equal to ⅓ of the Total Height 77. The Side Stem Width at ⅔ Height 79 is measured as the horizontal width of the stem 72 at a perpendicular distance from the base 71 equal to ⅔ of the Total Height 77.

The Front Stem Width 90 is measured as the front horizontal width of the stem 72, as shown in FIG. 13, at a perpendicular distance from the base 71 equal to ⅓ of the Total Height 77.

The J-type hook 70 has a longitudinal axis 80. As used herein, the term “longitudinal axis” refers to an imaginary line generally centered at the footprint of the base 71 longitudinally projecting through the distal end of the stem 72 to the tip 75 of the engagement end 73. The Length of the J-type hook 70 is equal to the length of the longitudinal axis 80.

The Curl 81 of the J-type hook 70 is the angle between: (a) the vertical line passing through the apex 76 of the J-type hook 70, and (b) the line which passes through the tip 75 of the engagement end 73 and the intersection of the longitudinal axis 80 and the vertical line passing through the apex 76.

The Slope 82 of the J-type hook 70 is the angle between: (a) the tangent line passing through the distal point 83 of the Stem Width at ⅔ Height 79 and which is included in the plane of symmetry of the protrusion, and (b) the base 71 of the J-type hook 70.

The Vertical Hook Gap 84 is the vertical distance between: (a) a horizontal line passing through the tip 75 of the engagement end 73, and (b) the base 71 of the J-type hook 70.

The Horizontal Hook Opening 85 is the horizontal distance between: (a) the point 86 at which a horizontal line passing through the tip 75 of the engagement end 73 intersects the stem 72, and (b) the tip 75 of the engagement end 73.

The Vertical Hook Opening 87 is the vertical distance between: (a) the point 88 of the interior surface of the engagement end 73 which is at the greatest perpendicular distance from the base 71, and (b) the tip 75 of the engagement end 73.

### Prong-type Hooks

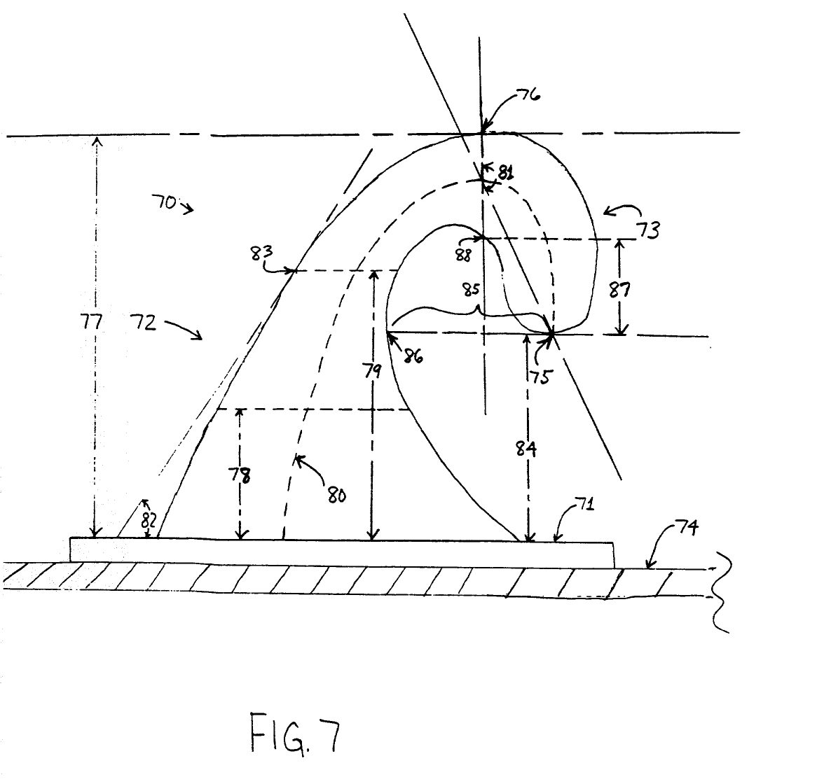

FIG. 8 is a side elevational view of a Prong-type hook 170 that is suitable as a protrusion for the present disposable cleaning sheets. The Prong-type hook 170 of FIG. 8 is defined by similar parameters as the J-type hook 70 of FIG. 7. The features of the Prong-type hook 170 are identified as three digit numerals starting with 1 and correspond to the features of the J-type hook 70 of FIG. 7.

### Mushroom-type Hooks

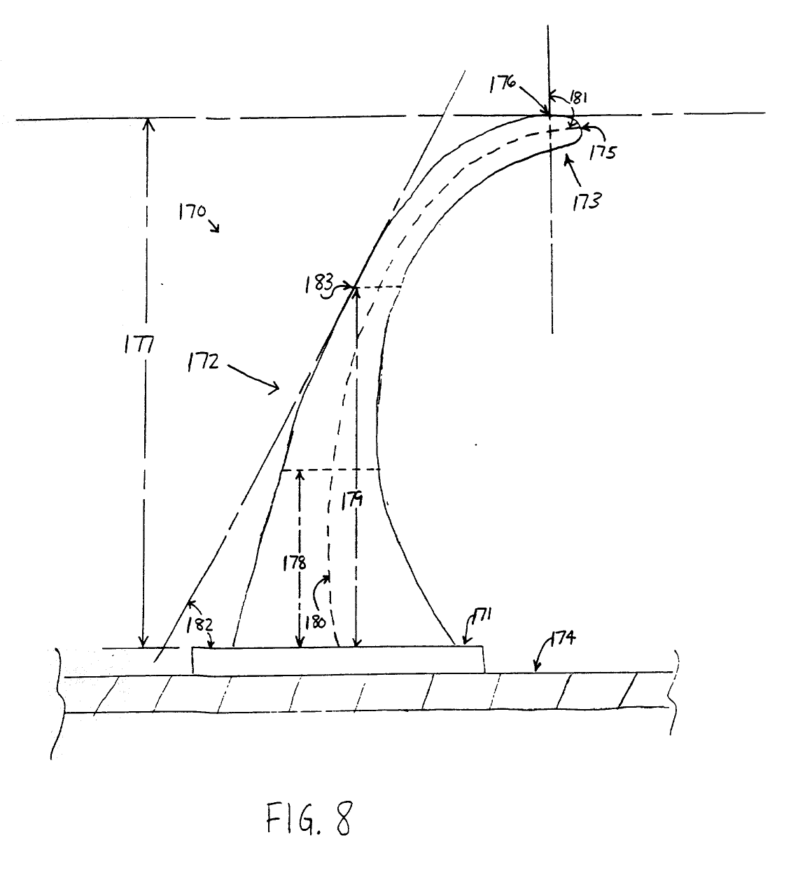

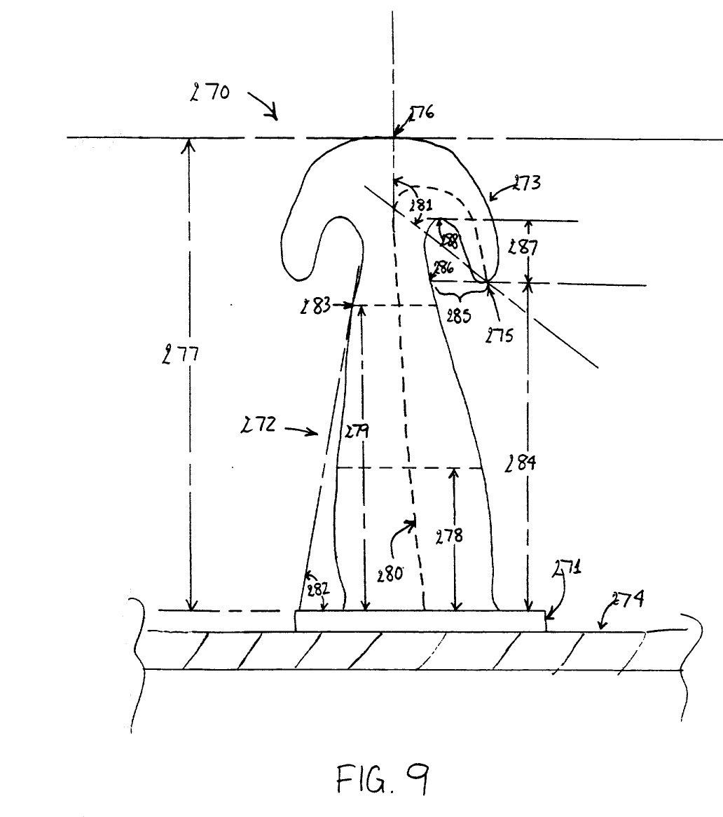

FIG. 9 is a side elevational view of a Mushroom-type hook 270 that is suitable as a protrusion for the present disposable cleaning sheets. The Mushroom-type hook 270 of FIG. 9 is defined by parameters similar to those of the J-type hook 70 of FIG. 7. The features of the Mushroom-type hook 270 are identified as three digit numerals starting with 2 and correspond to the features of the J-type hook 70 of FIG. 7.

### Banana-type Hooks

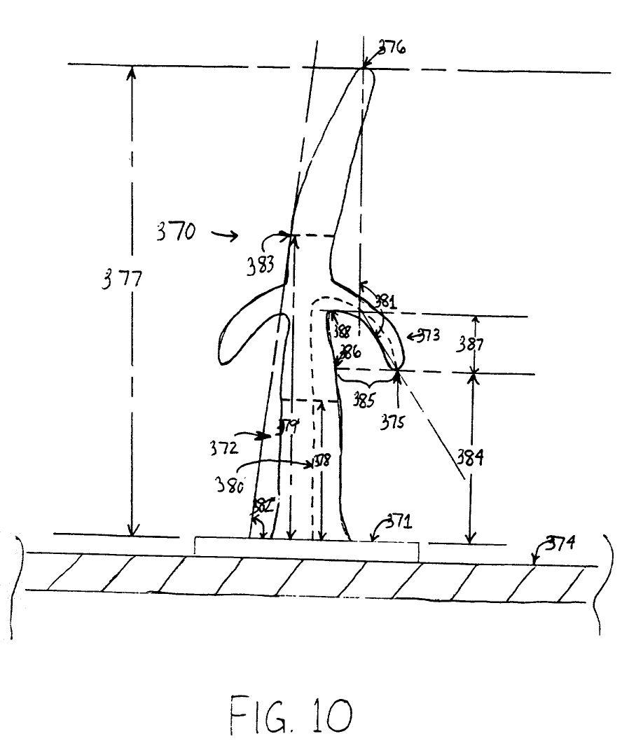

FIG. 10 is a side elevational view of a Banana-type hook 370 that is suitable as a protrusion for the present disposable cleaning sheets. The Banana-type hook 370 of FIG. 10 is defined by parameters similar to those of the J-type hook 70 of FIG. 7. The features of the Banana-type hook 370 are identified as three digit numerals starting with 3 and correspond to the features of the J-type hook 70 of FIG. 7. In one embodiment, the Banana-type hook can be assimilated to a J-type or Prong-type hook further comprising at least one, preferably two engagement ends extending from the stem of the hook at the same height and pointing towards different directions.

### Y-type Hooks

FIG. 11 is a side elevational view of a Y-type hook 470 that is suitable as a protrusion for the present disposable cleaning sheets. The Y-type hook 470 of FIG. 11 is defined by parameters similar to those of the J-type hook 70 of FIG. 7. The features of the Y-type hook 470 are identified as three digit numerals starting with 4 and correspond to the features of the J-type hook 70 of FIG. 7. In one embodiment, the Y-type hook 470 can be assimilated to two J-type hooks or two Prong-type hooks “sharing” the same base and stem but having two engagement ends facing opposite directions.

### Multi-tipped Hooks

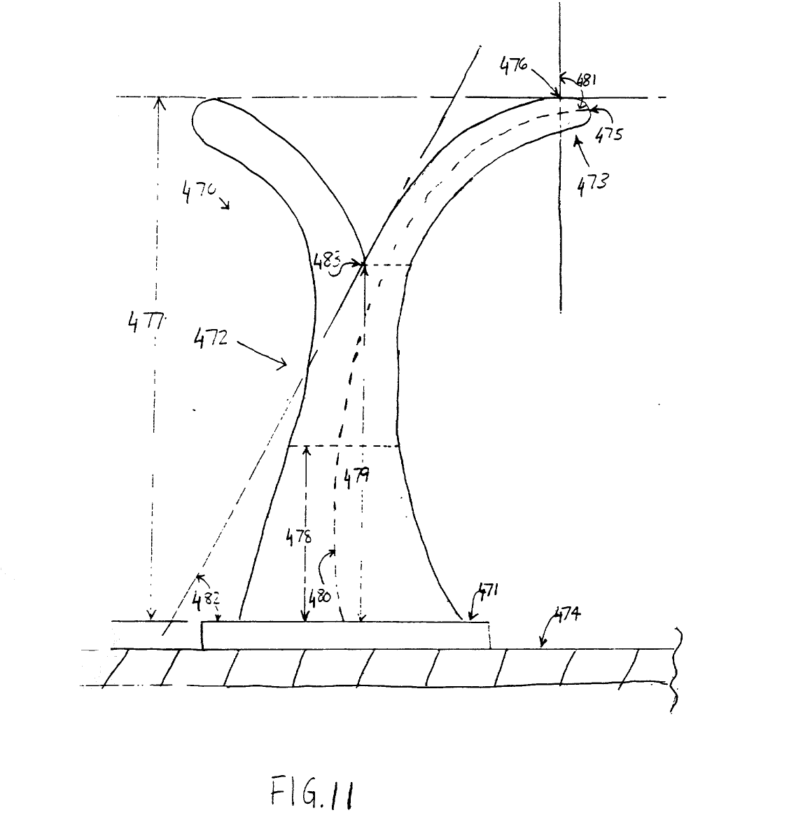

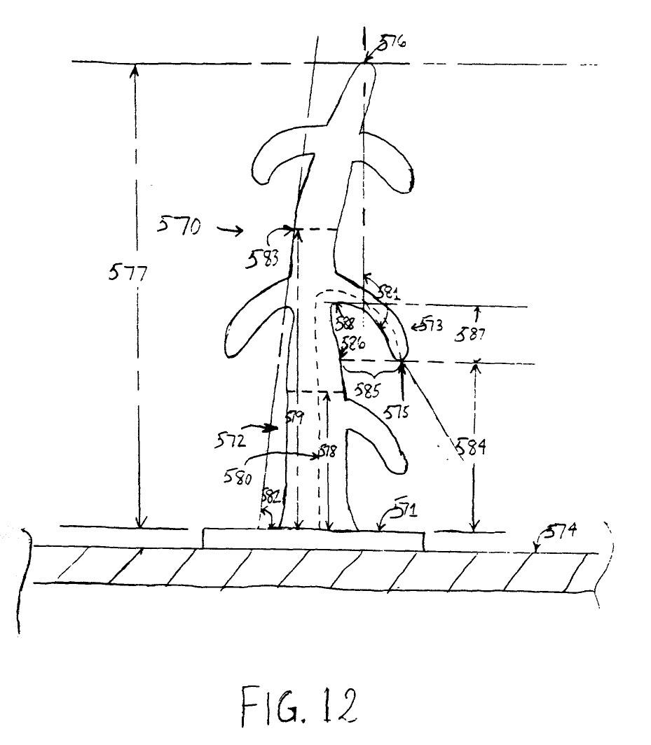

FIG. 12 is a side elevational view of a Multi-tipped hook 570 that is suitable as a protrusion for the present disposable cleaning sheets. The Multi-tipped hook 570 of FIG. 12 is defined by parameters similar to those of the J-type hook 70 of FIG. 7. The features of the Banana-type hook 570 are identified as three digit numerals starting with 5 and correspond to the features of the J-type hook 70 of FIG. 7. By Multi-tipped hook, it is meant a protrusion comprising a base, a stem and at least three engagement ends. In one embodiment of the invention, the Multi-tipped hook can be assimilated to at least three J-type or Prong-type hooks “sharing” the same base and stem but having three engagement ends pointing towards different directions. In another embodiment, the Multi-tipped hook can be assimilated to a Banana-type hook as previously described comprising a plurality of engagement ends extending from the stem of the hook at different heights and pointing towards the same or different directions

In one embodiment of the invention, the foregoing hook type protrusions can be disposed on the substrate forming the sheet such that the plane of symmetry of these protrusions is substantially parallel to the side edges of the sheet as shown if FIG. 1. This disposition of hooks can be achieved for example by placing at least one row of hooks on the substrate where all these hooks have a plane of symmetry which is perpendicular to this row and such that this row is perpendicular to the side edges of the sheet as shown in FIG. 1. A row of protrusions can be substantially linear but one skilled in the art will understand that other forms, shapes and/or configurations might be used and provide the same benefits. For example, the protrusions can be disposed such that they form a circle, a sinusoidal, an arc, or any other linear or non-linear shape.

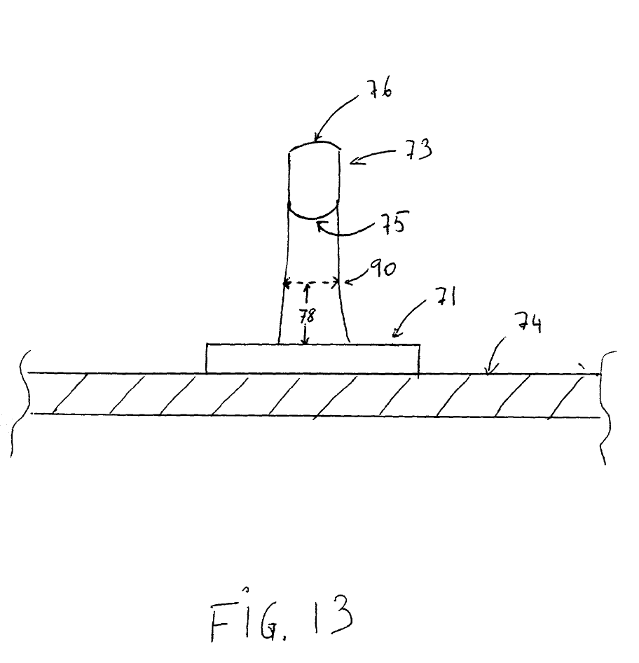

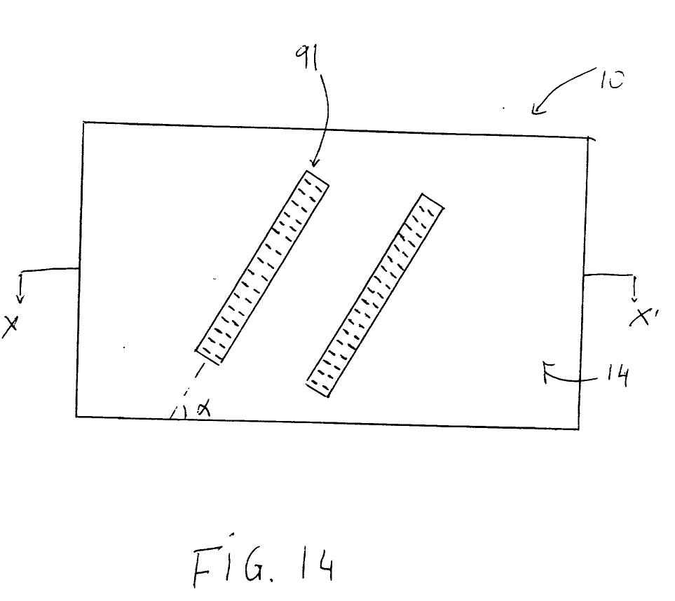

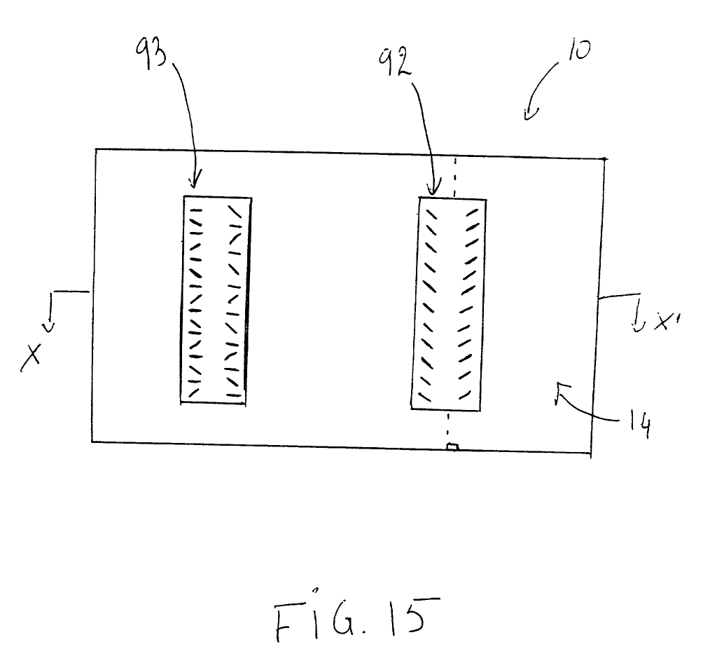

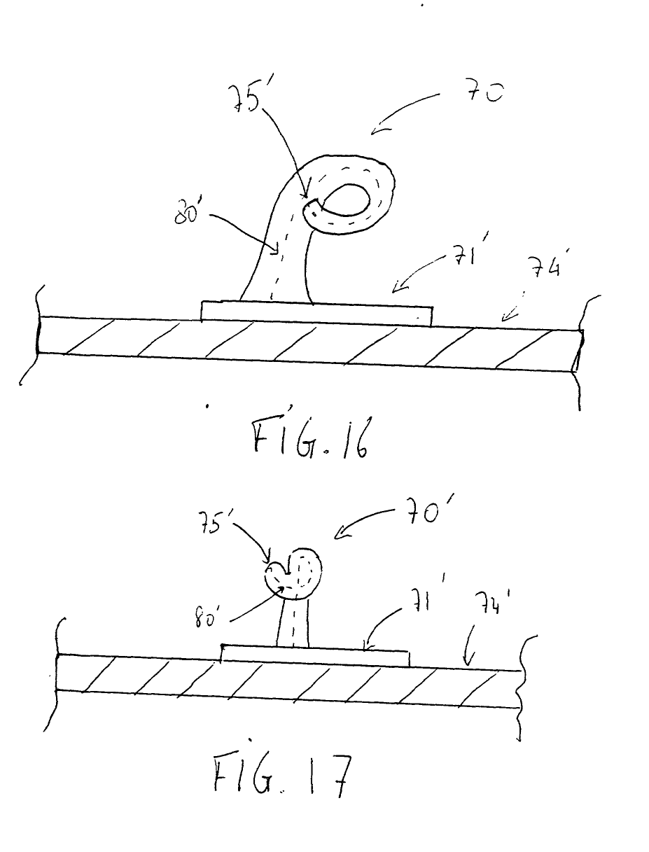

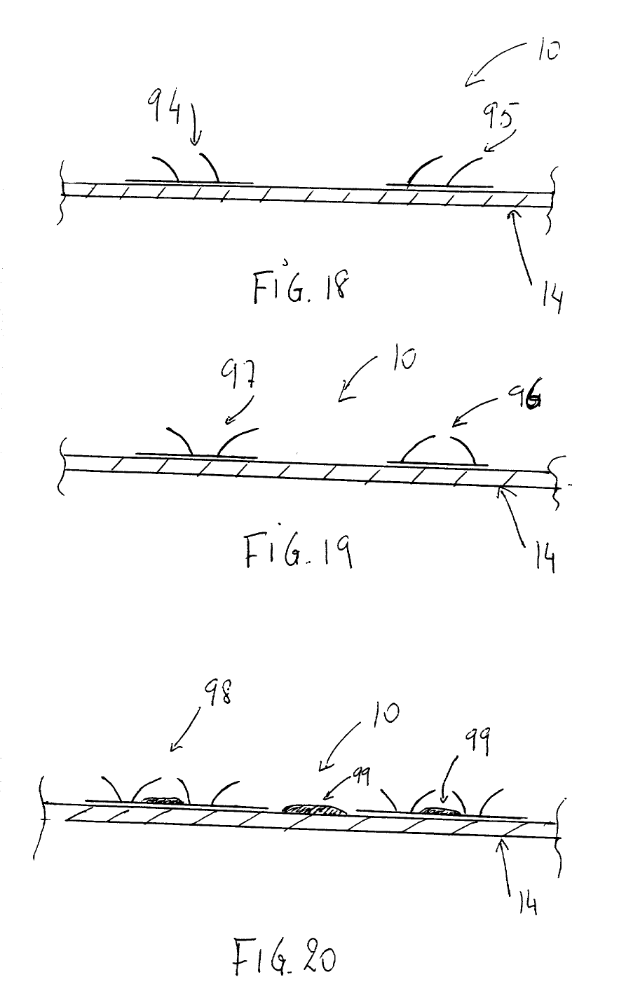

In another embodiment of the invention, the hook type protrusions can be disposed on the substrate such that the plane of symmetry of these protrusions is angled relative to the side edges of the sheet. This result can be achieved for example by placing at least one row of hooks on the substrate such that this substantially linear row of protrusions 91 is not perpendicular to the side edges of the sheet as shown in FIG. 14. Another possible way to achieve this result is to angle the hooks during the manufacturing process of the hooks. The strips 92 pre-angled of hooks can then be attached to the substrate such that each strip is perpendicular to the side edges of the sheet as schematically shown in FIG. 15. The angle between the plan of symmetry of the hook and one of the side edges can be comprised between about 0 and 55 degrees, preferably between 3 and 45 degrees and most preferably between 3 and 30 degrees. One skilled in the art will understand that the previous values of the angle between the plan of symmetry of the protrusions and one of the side edges of the sheet is given in the absolute but could also be negative values depending on the chosen referential. In another embodiment of the invention schematically represented in FIG. 15, a row of protrusions, all having a plane of symmetry, comprises a combination of protrusions having different angles relative to one of the side edges of the sheet. A non-limiting example of such a combination can be a row 93 comprising protrusions angled at 45 degrees, protrusions angled at 0 degree (i.e. being parallel to the side edges of the sheet) and protrusions angled at +45 degrees. One skilled in the art will understand that other combinations of hooks having different angles might be possible and provide the same benefits.

In another embodiment of the invention, the hook type protrusions, which are positioned on the substrate, do not have a plane of symmetry. This can be the case for example with a hook 70′ which has a single tip and where the longitudinal axis 80′ of this hook is not included in its entirety in a plane which is perpendicular to the basis of the hook as schematically represented in FIGS. 16 (for the side view) and 17 (for the front view). In this embodiment, the tip 75′ of the hook appears as if it were twisted out of the plane perpendicular to the base such as for example, the tip of a screw.

In another embodiment of the invention, a combination of hooks having a symmetrical plane being parallel to the side edges of the sheet and/or hooks having a symmetrical plane being angled relative to the side edges of the sheet and/or hooks having which do not have a plane of symmetry can be disposed on a sheet.

1. PROCESSES FOR MAKING PROTRUSIONS

The protrusions herein can be produced by a variety of processes. For example, the protrusions herein can be produced by an extrusion process, cut-loop formation process, modified gravure printing process, screen printing process, and the like.

The protrusions are preferably produced by an extrusion process. A preferred extrusion process comprises integrally molding a base and forming a plurality of protrusions spaced apart in rows extending along at least a portion of the length and width of the base. It is preferred that the base and protrusions are of the same composition. Extrusion processes for producing protrusions, especially the preferred hook-shaped protrusions disclosed herein, are described in U.S. Pat. Nos. 5,614,045; 4,056,593 and 4,872,243. The extruded protrusions produced thereby can include the base upon which adhesive tape or adhesive material can be applied for affixing the protrusions to the substrate of the present cleaning sheets. Suitable extruded protrusions for the present cleaning sheets are commercially available from APLIX®, Inc. While these references disclose methods for making hook shaped protrusions for fastener systems, the same methods can be applied to make the protrusions of the present invention. In one embodiment, strips comprising a plurality of protrusions are made by first extruding a strip of material which comprises longitudinal “ribs” on at least one side and second, by cutting notches across these ribs such that substantially hooked shaped protrusions are obtained. It might be preferred to stretch this strip of material in a drawing frame prior to cutting the notches in order to increase the space between the hook shaped protrusions.

Another process of making protrusions includes a coextrusion process such as the one described in U.S. Pat. No. 6,106,922 issued August 2000 to Cejka et al. In this process, two layers of material which can be meltable and have different properties, are coextruded to form protrusions such that these protrusions comprise a core of a first material and an outer layer formed of a second material.

Another process for making protrusions includes a cut-loop formation process. A cut-loop process is commonly used to make hook fastener systems and comprises fabricating a series of relatively stiff loops on a surface and cutting these loops to form a long, curved side that forms a hook and a shorter, straight protrusion (e.g. bristle). A cut-loop formation process is described in U.S Pat. No. 3,785,012. Suitable hook-shaped protrusions made from a cut-loop formation process include those commercially available from Velcro Industries B.V. under the trade name VELCRO®. Preferred cut-loop hooks include VELCRO® Model #088 and cut-loop hooks used in a commercially available hair roller. As with extruded protrusions, cut-loop protrusions can include a base upon which adhesive tape or adhesive material can be applied for affixing the protrusions to the substrate of the present cleaning sheets.

The protrusions can also be produced using a modified gravure printing process or a screen printing process, by printing the thermoplastic resin/polymer in its molten state onto the substrate in discrete units, severing the material in a manner that allows stretching of a portion of the thermoplastic resin/polymer prior to severance, and allowing the stretched molten material to “freeze” resulting in protrusions. These “printed” protrusions and methods and apparatus for making such “printed” protrusions are more fully detailed in U.S. Pat. No. 5,230,851 issued Jul. 27, 1993 to Dennis A. Thomas; U.S. Pat. No. 5,058,247, issued Oct. 22, 1991 to Dennis A. Thomas and Ted L. Blaney; and U.S. Pat. No. 5,116,563, issued May 26, 1992 to Dennis A. Thomas and David J. K. Goulait.

Processes of orienting “printed” protrusions relative to the machine direction, are disclosed in U.S. Pat. No. 5,180,534 issued Jan. 19, 1993 to Dennis A. Thomas, David J. K. Goulait, and Robert G. Cox, Jr.

2. AFFIXING PROTRUSIONS TO THE SUBSTRATE

The protrusions can be formed on a base material discrete from the substrate of the present cleaning sheets to create a strip of material having protrusions and then cut and affixed to the substrate of the cleaning sheet. Processes such as extrusion or cut-loop formation can be used to form protrusions on a base material. In these processes, the base material upon which the protrusions are formed will typically have adhesive tape or adhesive material, preferably a hot melt pressure sensitive adhesive, applied thereto to facilitate affixing the protrusions and/or base material to the substrate. The strips of protrusions can also be affixed to the substrate via heat bonding. In another embodiment, an adhesive material, which can be a hot melt adhesive, is first applied to the substrate. Then, one or more strips of comprising a plurality of protrusions is applied to the adhesive coated substrate.

A base can comprise a plurality of protrusions and the base can be affixed to the substrate as a single piece or in multiple strips. In a preferred embodiment, multiple strips of a base comprising a plurality of protrusions are applied to the substrate parallel to one another, with each strip having the same or different combination of protrusion shapes.

In another embodiment, a strip of base material comprising protrusions on at least one surface can be removably attached to a cleaning device such as a cleaning implement or a cleaning mitt or even be used by hand without the need for an additional device. A non-limiting example can be a strip of base material comprising on at least one surface, a plurality of protrusions, such as the ones previously described, and also having means for fastening the strip to a cleaning device. Suitable examples of means for fastening the strip can be, a pressure sensitive adhesive applied to a surface of the strip and/or a surface of the cleaning device such that the strip is retained about the cleaning device when the strip and cleaning device are in contact, any type of elastic band, hooks or loops fasteners for engaging loops or hooks fasteners, mechanical means such as grippers or clips and any combinations thereof.

The protrusions can also be formed directly on the substrate of the present cleaning sheets as the cleaning sheet is being made, and the orientation of the protrusions can be controlled by azimuthally angling the individual protrusions according to the processes of the above-referenced patents. In this aspect, the protrusions can be “printed” directly onto the substrate of the present cleaning sheets.

### Local Distribution of the Protrusions on the Base

In one embodiment of the invention, the base or strip of material, which is discrete from the substrate, comprises at least one row of protrusions. An odd number of rows of protrusions can be formed onto the strip of material but an even number of rows may be preferred. The local distribution and orientation of the protrusions on each row may impact on the glide or coefficient of friction of the sheet onto a surface as well as its cleaning performance. When the base material forming the strip comprises two rows of prong-type protrusions, 4 possible arrangements can be used to make the base as shown in FIG. 18 and FIG. 19. For example, a strip 94 or 95 can comprise two rows of protrusions pointing towards the same direction It is also possible to have a strip 96 comprising protrusions where the first row of protrusion can be facing the second row of protrusions. It is also possible to have a strip 97 having two rows of protrusions pointing towards opposite directions. One skill in the art will understand that the more rows are formed in the base material, the more arrangements of these rows can be created. If N is the integer number equal to the number of rows, the number of arrangements can be determined by using the mathematical formula 2^{N}. In a preferred embodiment shown in FIG. 20, the base material comprises four rows of protrusions such that the 2 outer rows are pointing towards opposite directions and the 2 inner rows are facing each other. Without intending to be bound by any theory, it is believed that this disposition is particularly suitable for better hair pick up since the 2 inner rows can “trap” hairs by acting like “pliers”. This is particularly true when an additive such as a pressure sensitive adhesive 99 is applied to the protrusion or in the alternative between the rows of protrusions. In addition, this bidirectional distribution of protrusions improves hair pick up when the sheet is moved forward and backward on the soft surface. One skilled in the art will understand that the foregoing number of arrangements is given with the assumption that the protrusions of a single row are pointing towards the same direction and can be preferred for ease of manufacturing. However, it will be understood that it might be possible to have rows of protrusions where not all the protrusions of a single row are pointing towards the same direction. One skill in the art will also understand that a base material comprising several rows of protrusions can be attached to the substrate but that the same benefits may be obtained when several “strips” of base material comprising a single row of protrusions are attached to the substrate to form a sheet.

In one embodiment for use with an implement on carpeting, less than about 50%, preferably less than about 33% of the protrusions are made of a low density polyethylene or any equivalent soft polymers, and more than about 50%, preferably more than about 67%, more preferably 100% of the protrusions are made of a polypropylene or any equivalent polymers having similar hardness. It can also be preferred that the front stem width is form about 0.15 mm to about 0.30 mm, and the distance between protrusions in a row is from about 0.6 to about 1.8 mm, even more preferably, from about 1.0 to about 1.5 mm. In a preferred embodiment, the cleaning sheet comprises prong-type protrusions. Preferably more than 50% of the protrusions are prong-type protrusions, even more preferably more than 85% of the protrusions are prong-type protrusions.

In another embodiment, a cleaning sheet which can be used by hand on upholstery, comprises at least about 33%, preferably at least about 75%, more preferably 100% of the protrusions which are made of a low density polyethylene or any equivalent soft polymer, and less than about 67%, preferably less than about 25% of protrusions made form polypropylene or any equivalent polymers having similar hardness polymers. It can be preferred to have protrusions having a front stem width comprised between about 0.15 mm to about 0.3 mm, preferably between about 0.15 mm to about 0.25 mm, and rows of protrusions such that the distance between 2 consecutive protrusions in a given row is comprised between about 0.6 mm to about 1.8 mm, preferably between about 0.9 mm to about 1.8 mm. It can also be preferred that the protrusions of this cleaning sheet are predominately prongs, preferably between about 50% to about 100% of the protrusions are prong-type protrusions, more preferably more than about 80% of the protrusions are prong-type protrusions.

### Zoned Application of Protrusions

The protrusions of the present cleaning sheets can be distributed in a random or non-random pattern on the substrates of the present cleaning sheet. The protrusions can be arranged in one or more discrete “zones” with respect to the substrate of the cleaning sheet, wherein each zone comprises a plurality of protrusions. Each zone is typically adjacent to an area of the substrate that is free of protrusions.

The present cleaning sheets preferably comprise at least two discrete zones of protrusions, more preferably at least three discrete zones of protrusions, and even more preferably at least four discrete zones of protrusions, wherein each zone comprises a plurality of protrusions.

For example, FIG. 1 depicts a cleaning sheet 10 of the present invention wherein the protrusions 12 are affixed to the substrate 14 in two discrete zones 16, wherein each zone 16 comprises a plurality of protrusions 12. FIG. 2, which is a cross-section of the cleaning sheet 10 of FIG. 1, shows the arrangement of protrusions 12 in each zone 16.

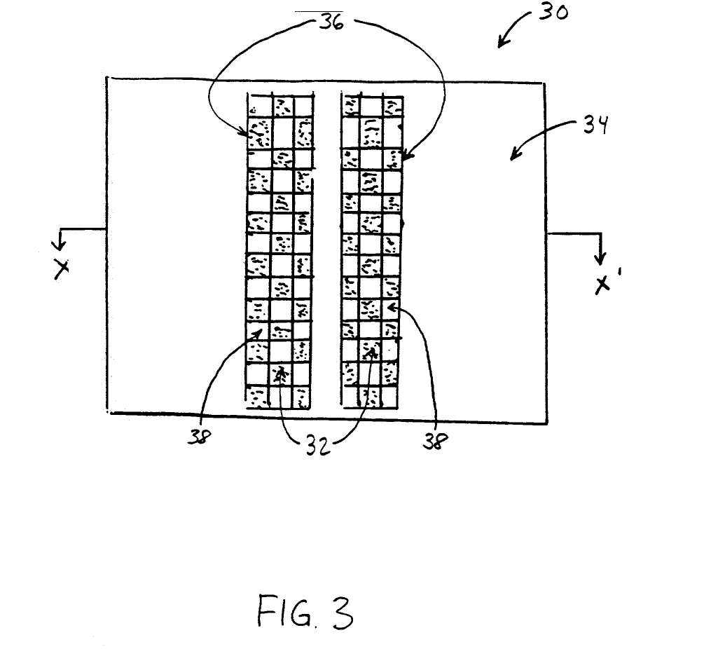

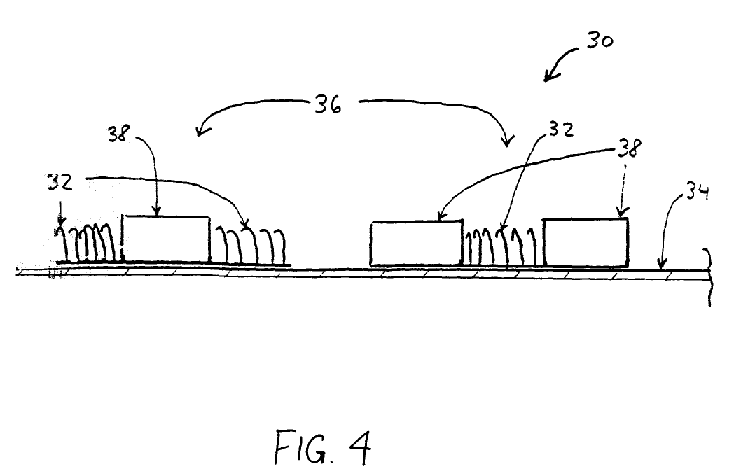

FIG. 3 depicts another embodiment of a cleaning sheet 30 of the present invention wherein the protrusions 32 are affixed to the substrate 34 of the cleaning sheet 30 in two discrete zones 36, wherein each zone 36 comprises a plurality of protrusions 32 and polymeric additive material 38 disposed in a checkerboard pattern. FIG. 4, which is a cross-section of the cleaning sheet 30 of FIG. 3, shows the arrangement of the protrusions 32 and polymeric additive material 38 in each zone 36. In this embodiment, the height of the polymeric additive material 38, with respect to the substrate 34, is preferably equal to or greater than the height of at least some of the protrusions 32.

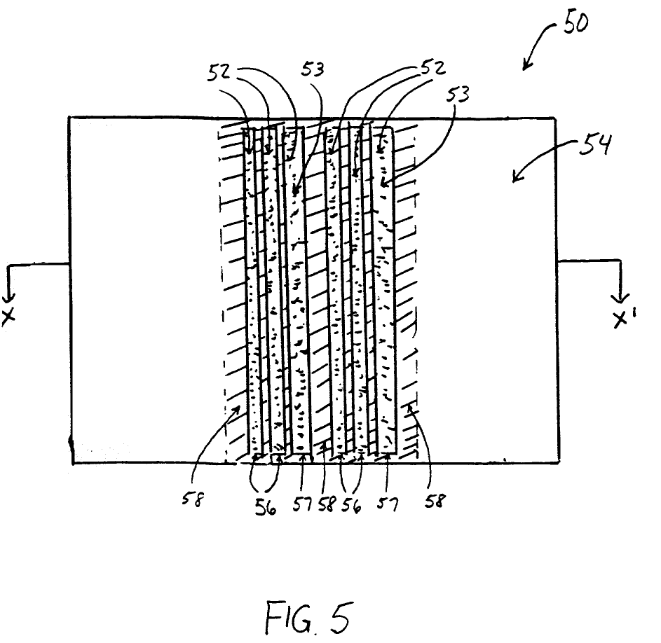

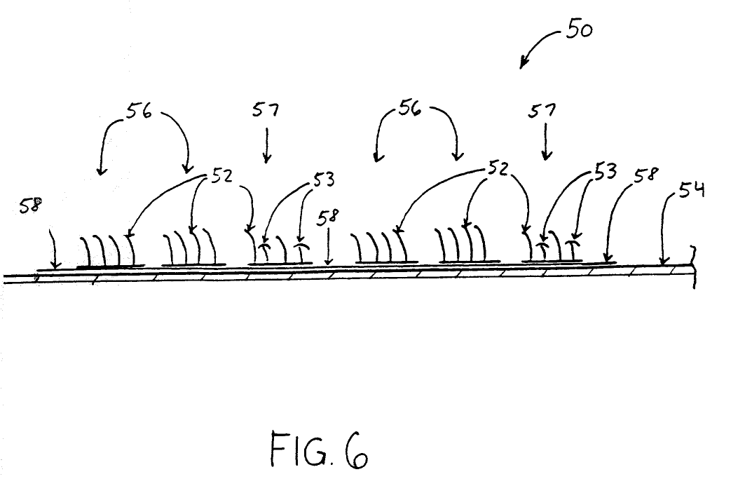

FIG. 5 shows another embodiment of a cleaning sheet 50 of the present invention wherein the protrusions 52, 53 are affixed to the substrate 54 of the cleaning sheet 50 in six discrete zones 56, 57, wherein each zone 56, 57 comprises a plurality of protrusions 52, 53. Adhesive material 58 is disposed between the discrete zones 56, 57 of protrusions 52, 53. FIG. 6, which is a cross-section of the cleaning sheet of FIG. 5, shows that certain zones 56 contain only prong-type protrusions 52, while other zones 57 contain a combination of prong-type protrusions 52 and mushroom-type protrusions 53. FIG. 6 also shows adhesive material 58 affixed to the substrate 54 between the discrete zones 56, 57 of protrusions 52, 53.

In a preferred embodiment, the protrusions are arranged in a zone on the substrate of the cleaning sheet that is centered on the substrate, such that when the cleaning sheet is attached to a mop head of a cleaning implement, the protrusions are aligned with the bottom surface (and/or sides) of the mop head so as to be contacted with the surface to be cleaned. The areas of the substrate of the cleaning sheet adjacent to the centered zone comprising a plurality of protrusions are free of protrusions and can be used to attach the cleaning sheet to the mop head of the cleaning implement, as shown in FIG. 11.

In another preferred embodiment, when a cleaning sheet of the present invention is attached to a mop head of a cleaning implement, a plurality of protrusions are affixed to the substrate in a zone along the leading and/or trailing edge of the mop head, or around the vertical edges of the mop head.

In yet another embodiment, a cleaning sheet can comprise any of the previously described protrusions, combination of protrusions, rows of protrusions and/or zoned application of protrusions, on both sides of the sheet. This embodiment offers the advantage of doubling the “mileage” of a single sheet. A user can simply attach the sheet to a cleaning implement as later described and use it to clean a soft surface. When the sheet appears “saturated” with hair or particles, the user can simply remove the sheet from the implement, and re-attach the sheet such that the still clean side of the sheet can now be used to clean the soft surface.

C. ADDlTIVE MATERIAL

The present disposable cleaning sheets can optionally, but preferably, further comprise an additive material. The additive material can be affixed to the substrate of the present cleaning sheets in order to enhance the ability of the present cleaning sheets to better retain debris, especially small particulate matter, that has been removed from a surface being cleaned.

A number of additive materials can be suitable for incorporation into the cleaning sheets of the present invention. Preferred additives of the present invention that are particularly useful with the present cleaning sheets are polymeric additives, especially those with specific adhesive characteristics such as specific Tack Values, Adhesive Work Values, Cohesion/Adhesion Ratios, Stringiness Values, T_{g} Values, and/or molecular weight. Other optional additive materials in the present invention include, but are not limited to waxes, oils, powders, and mixtures thereof. The additive material is selected in order to improve the pick-up of fine particulate matter such as dust, lint, and hair, and especially larger particulate matter typically found on household floors and surfaces such as crumbs, dirt, sand, hair, crushed food, grass clippings and mulch. In addition, the type and amount of the additive material is carefully selected in order to improve particulate pick-up of the cleaning sheet, while maintaining the ability of the cleaning sheet to easily glide across the surface being cleaned. If the cleaning sheet is too tacky as a result of the additives incorporated therein, the cleaning sheet will not easily glide across the surface, leading to consumer dissatisfaction.

Preferred polymeric additives include, but are not limited to, those selected from the group consisting of pressure sensitive adhesives, tacky polymers, and mixtures thereof. Suitable pressure sensitive adhesives comprise an adhesive polymer, which is optionally in combination with a tackifying resin, plasticizer, and/or other optional components. Suitable tacky polymers include, but are not limited to, polyisobutylene polymers, N-decylmethacrylate polymers, and mixtures thereof.

Preferred pressure sensitive adhesives are selected for incorporation in the present cleaning sheets based on the adhesive characteristics of the pressure sensitive adhesive, including Adhesive Work Value, Tack Value, Cohesive/Adhesive Ratio, and Stringiness Value. These adhesive characteristics, and methods for measuring such adhesive characteristics, have been described in detail in co-pending U.S. application Ser. No. 09/821,953 filed Mar. 30, 2001 by Kacher et al.

Preferred pressure sensitive adhesives typically exhibit an Adhesive Work Value at 5 grams of pressure of from about 130 to about 1000, preferably from about 160 to about 750, and more preferably from about 250 to about 650.

In general, the Tack Value at 5 grams of pressure of the pressure sensitive adhesives is from about 100 to about 500, preferably from about 150 to about 400, and more preferably from about 200 to about 350.

A typical Cohesive/Adhesive Ratio at 5 grams of pressure of the present pressure sensitive adhesives is from about 0.2 to about 30, preferably from about 1.0 to about 6.0, and more preferably from about 3.0 to about 6.0.

The present pressure sensitive adhesives normally have a Stringiness Value at 5 grams of pressure of from about 2.5 to about 12.0, preferably from about 2.5 to about 8.5, and more preferably from about 3.0 to about 5.0.

Examples of preferred pressure sensitive adhesives for use in the present cleaning sheets herein include, but are not limited to, a series of pressure sensitive adhesives commercially available from H.B. Fuller Company under the trade names HL-1496, HL-1500, HM-1597, HM-1902, HM-1972, HM-2713, and the like. Other preferred pressure sensitive adhesives include those available from the Rohm & Haas Company under the trade names ROBOND® PS 75R, ROBOND® PS 20, RHOPLEX® VS; ACRONOL® DS 3432, and mixtures thereof.

The additive material herein can also be a silicone polymeric additive material, such as household silicone adhesive caulk material.

The additive material can be affixed to the substrate itself, or can be affixed to the protrusions herein, which are then affixed to the substrate. The additive material can be applied uniformly to the substrate and/or protrusions, or can be applied in “zones”. When applying the additive material in zones, the additive material can be applied in a random or non-random pattern, such as a checkerboard pattern, as shown in FIGS. 3 and 4. In a preferred embodiment, the additive material is distributed evenly across a wide central portion of the substrate. The strips of protrusions are then applied on the additive such that the strips are secured to the substrate. It can also be preferred to leave a space in between each strips of protrusions such that a portion of the additive which is not covered by any strips can contribute to debris and hair pick up.

Other suitable additive materials include wax, oil, powder, and mixtures thereof. Preferred wax is paraffin wax and preferred oil is mineral oil. Suitable powders for use herein include, but are not limited to, those selected from the group consisting of talc, starch, magnesium carbonate, and mixtures thereof.

Other additive materials include perfumes, pest control ingredients, antimicrobials, including fungicides, and the like. Preferred additive materials are described in detail in co-pending U.S. application Ser. No. 09/821,953 filed Mar. 30, 2001 by Kacher et al.

Typically, the additive materials, such as polymeric additives, are impregnated onto the present cleaning sheets at a level of polymeric additive of no greater than about 10.0 g/m², preferably no greater than about 6.0 g/m², more preferably no greater than about 4.0 g/m², and still more preferably no greater than about 2.0 g/m². Also, the additive materials, such as polymeric additives, are typically impregnated onto the present cleaning sheets at a level of polymeric additive of at least about 0.1 g/m², preferably at least about 0.2 g/m², more preferably at least about 0.4 g/m², and still more preferably at least about 0.6 g/m².

The polymeric additive can be applied directly to the substrate by any conventional means such as spraying, slot coating, printing, or kiss coating. When an additive material such as polymeric additives, is applied to the protrusions, it might be preferred to have a majority of the additive be located at the lower half of the protrusions (i.e. closer to the protrusions' base or away from the protrusions' tip). In one embodiment, an aqueous dispersion of polymeric additive is sprayed on the protrusions. It was observed that the sprayed solution drains from the tip towards the base prior to drying when the sheet lays flat. In another embodiment, the polymeric additive is applied directly to the base of the protrusions by applying the polymeric additive by co-extrusion or other distribution means between the rows of protrusions.

When the polymeric additives are aqueous dispersions, it can be desirable to obtain good wetting and spreading on the hydrophobic prong surface. In one embodiment, a coating composition is added to the hydrophobic prong surface prior to the addition of the polymeric additive. The coating composition comprises aqueous mixtures of components selected from the group consisting of hydrophilic nanoparticles, nonionic surfactants, anionic surfactants, and mixtures thereof.

Suitable examples of nanoparticles that can be used are disclosed in Copending U.S. Pat. application to Cramer et al., Ser. No. 10/060,582 filed Jan. 30, 2002 which includes particles with a largest dimension (e.g., a diameter) of less than, or less than or equal to about 750 nm (nanometers). The particles that are useful can also include any set of particles that have a largest dimension that is less than, or less than or equal to any number which is an increment of 5 nm less than 750 nm, and in some cases may even include larger particles. Also incorporated and included herein, as if expressly written herein, are all ranges of particle sizes that are between 0 nm and 750 nm. Synthetic hectorite is a suitable nanoparticle which was first synthesized in the early 1960's and is now commercially marketed under the trade name LAPONITE™ by Southern Clay Products, Inc. There are many grades or variants and isomorphous substitutions of LAPONITE™ marketed. Examples of commercial hectorites are LAPONITE B™, LAPONITE S™, LAPONITE XLS™, LAPONITE RD™, LAPONITE XLG™, and LAPONITE RDS™. One embodiment of this invention uses LAPONITE XLS™ having the following characteristics: analysis (dry basis) SiO2 59.8%, MgO 27.2%, Na2 O 4.4%, Li2 O 0.8%, structural H2 O 7.8%, with the addition of tetrasodium pyrophosphate (6%); specific gravity 2.53; bulk density 1.0. In one embodiment, a surfactant is used in the coating composition. This surfactant may be added at an effective amount to facilitate the application of the coating composition and/or to provide one, or more of the benefits described herein. Typically, surfactants can be included in an amount from about 0.01% to about 60%, or more, by weight of the composition, or any amount or range within this range, including, but not limited to from about 0.01% to about 20%, and from about 0.01% to about 10%.

Non-limiting examples of surfactants, including other nonionic surfactants, useful herein typically at levels from about 1% to about 50%, by weight, include the conventional C11-C18 alkyl benzene sulfonates (“LAS”) and primary, branched-chain and random C10-C20 alkyl sulfates (“AS”), the C10-C18 secondary (2,3) alkyl sulfates of the formula CH3(CH2)x(CHOSO3-M+) CH3 and CH3 (CH2)y(CHOSO3-M+) CH2CH3 where x and (y+1) are integers of at least about 7, alternatively at least about 9, and M is a water-solubilizing cation, especially sodium, unsaturated sulfates such as oleyl sulfate, the C10-C18 alkyl alkoxy sulfates (“AE×S”; especially EO 1-7 ethoxy sulfates), C10-C18 alkyl alkoxy carboxylates (especially the EO 1-5 ethoxycarboxylates), the C10-18 glycerol ethers, the C10-C18 alkyl polyglycosides and their corresponding sulfated polyglycosides, and C12-C18 alpha-sulfonated fatty acid esters. If desired, the conventional nonionic and amphoteric surfactants such as the C12-C18 alkyl ethoxylates (“AE”) including the so-called narrow peaked alkyl ethoxylates and C6-C12 alkyl phenol alkoxylates (especially ethoxylates and mixed ethoxy/propoxy), C12-C18 betaines and sulfobetaines (“sultaines”), C10-C18 amine oxides, and the like, can also be included in the overall compositions. The C10-C18 N-alkyl polyhydroxy fatty acid amides can also be used. Typical examples include the C12-C18 N-methylglucamides. See WO 9,206,154. Other sugar-derived surfactants include the N-alkoxy polyhydroxy fatty acid amides, such as C10-C18 N-(3-methoxypropyl) glucamide. The N-propyl through N-hexyl C12-C18 glucamides can be used for low sudsing. C10-C20 conventional soaps may also be used. If high sudsing is desired, the branched-chain C10-C16 soaps may be used. Mixtures of anionic and nonionic surfactants are especially useful. Other conventional useful surfactants are listed in standard texts.

The coating composition can be applied by either dipping the protrusions in the coating composition, or by spraying the coating composition on the surface, or in the alternative by slot or kiss coating the coating composition across the protrusions surface, or by any other conventional means of coating an aqueous solution on a surface. The polymeric additive can be applied directly after said coating composition is added or but it might be preferred to apply the polymeric additive once the coating composition has dried.

The present cleaning sheets are preferably free of abrasive materials, including abrasive particles, such as aluminum oxide, having a grit size of from about 280 to about 600.

### II. CLEANING IMPLEMENTS

The disposable cleaning sheets of the present invention are preferably attached to a mop head of a cleaning implement. The cleaning implement can then be used to move the disposable cleaning sheet across the surface being cleaned, e.g. carpet. After the surface has been cleaned, the disposable cleaning sheet can be removed from the mop head of the cleaning implement and discarded.

The cleaning implement preferably comprises a handle and a mop head. The mop head is attached to the handle via a joint. The joint can be any number of suitable joints, for example, universal joint, ratcheted joint, ball and socket joint, and the like. Preferably, the joint is a “lockable joint”. As used herein, the term “lockable joint” refers to a joint that can be locked into a certain position such that the mop head and handle do not freely move with respect to one another.

The cleaning implement preferably comprises gliders, which can be attached to, or incorporated into, the bottom surface of the mop head of the cleaning implement. Gliders are preferred because some embodiments of the present cleaning sheets having excellent debris removing and retaining performance can exhibit good glide characteristics on certain surfaces, such as plush carpet, but exhibit poor glide characteristics on other surfaces, such as berber carpet, when the cleaning sheet is flat and in full contact with the surface. Suitable gliders are described in co-pending U.S. Provisional Application Serial No. 60/300,765 filed Jun. 25, 2001 by Streutker et al. (P&G Case 8606P), and U.S. Provisional Application Serial No. 60/370,871 filed Apr. 8, 2002 by Streutker et al. (P&G Case 8606P2). To further improve glide characteristics when a present cleaning sheet is attached to a cleaning implement, the mop head of the cleaning implement can have curved profile on the bottom surface of the mop head. Suitable mop heads have curved bottom surfaces are described in co-pending U.S. application Ser. No. 09/821,953 filed Mar. 30, 2001 by Kacher et al.

Suitable cleaning implements are shown in U.S. Design Pat. Nos. D-409,343; and D-423,742. Preferred cleaning implements are described in detail in co-pending U.S. Provisional Application Serial No. 60/300,765 filed Jun. 25, 2001 by Streutker et al. (P&G Case 8606P), and U.S. Provisional Application Serial No. 60/370,871 filed Apr. 8, 2002 by Streutker et al. (P&G Case 8606P2).

A preferred cleaning implement is shown in FIG. 21. The cleaning implement 630 comprises a handle 632 and a mop head 634. The mop head 634 is attached to the handle 632 by a lockable joint 636. The mop head 634 includes a pair of spring-loaded gliders 638, which facilitate the movement of the cleaning implement 630 across the surface being cleaned.

A cleaning sheet 639 of the present invention is attached to the mop head 634 via four grippers 635 located near the four corners of the mop head 634. The lockable joint 636 can be unlocked by twisting the handle 632 clockwise. Once the lockable joint 636 is unlocked, the handle 632 can be adjusted to increase or decrease the angle between the handle 632 and the mop head 634. Once the desired angle is obtained, the lockable joint 636 can be locked by twisting the handle 632 counterclockwise. Once the handle 632 and lockable joint 636 is locked into the desired position, the user can then clean a surface by moving the cleaning implement 630 across the surface.

The present cleaning sheet can be attached to the cleaning implement via a number of attachments. “Grippers” are preferred way to attach the present cleaning sheets to a cleaning implement, as shown in FIG. 21. Preferred grippers are described in detail in co-pending U.S. application Ser. No. 09/374,714 filed Aug. 13, 1999 by Kingry et al. Another way to attach the present cleaning sheets to a cleaning implement is via a hook-and-loop fastener system. If a hook-and-loop fastener system is used, the substrate of the cleaning sheet will have either hooks or loop material affixed to the surface of the substrate in contact with the mop head of the cleaning implement, which will have complementary loop or hook material affixed thereto to engage the hook or loop material of the cleaning sheet. One skilled in the art will understand that other types of implement might be used in conjunction with the cleaning sheet. A non-limiting example of implement can be a handle where a portion of this handle can be “gripped” by the user's hand and another portion of the handle can be used to retain a sheet. This type of implement might be particularly suitable for hard to reach areas and/or small surfaces to be cleaned.

### III. HAND USE

A cleaning sheet comprising protrusion can be used with an implement in order to remove particles such as lint or hair from a soft surface such as a carpet or upholstery. However, for ease of use of the cleaning sheet on surfaces which are not substantially flat like the fabric covering furniture or which have dimensions rendering the use of the cleaning implement previously described not convenient, the present invention also relates to the use of a previously described sheet by a user without any implement. For example a user may want to use any of the previously described sheets as she would use a wipe.

In another embodiment, a cleaning sheet can be held against the hand of a user by elastic bands wrapped around both the hand and the cleaning sheet which provide a good grip during use. In still another embodiment, the lengthwise edges of the sheet comprise attachment means such as for example, an adhesive or hook and loop fastener for connecting one end to the other. In this embodiment, the ends of the sheet can be wrapped around the hand and secured to one another to form a snug fit.

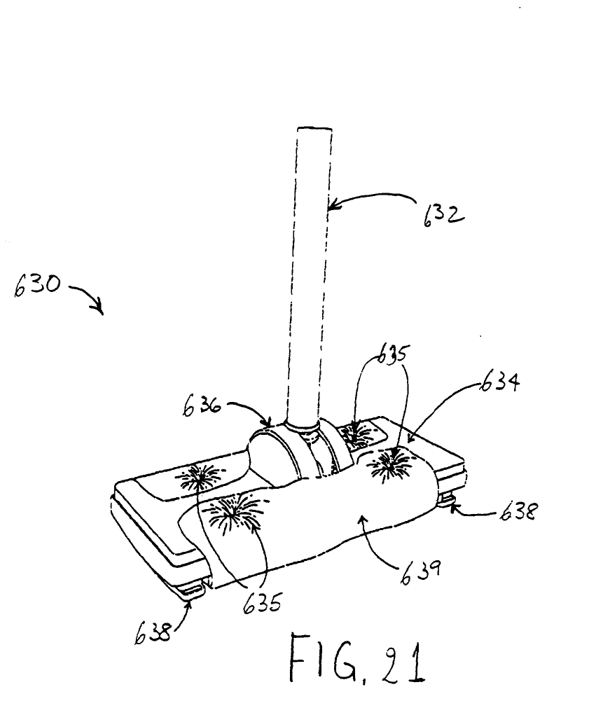

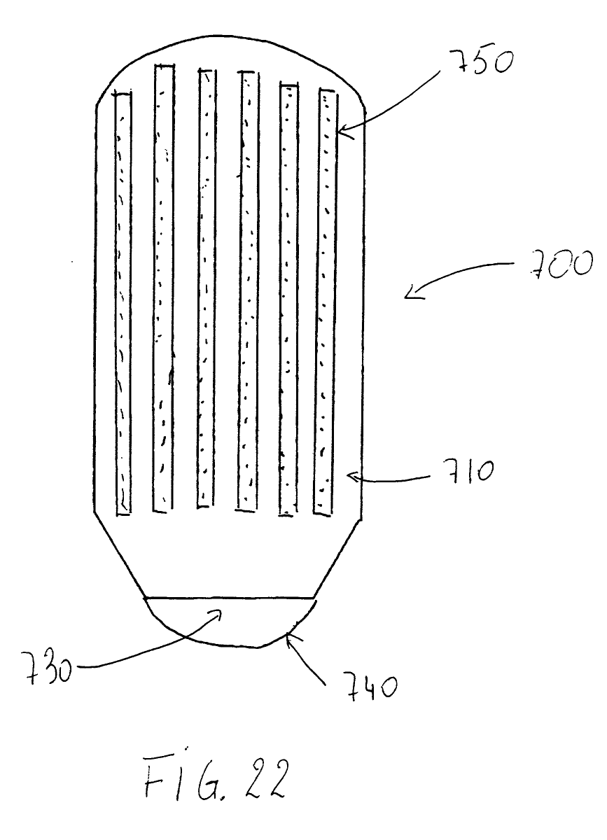

In another embodiment of the invention, schematically represented in FIG. 22, any of the previously described sheets can be used to form a disposable mitt 700 comprising at least a layer of substrate having protrusions. A non-limiting example of a cleaning mitt can comprise a first side 710 having a first internal surface and a first external surface, a second side 720 having a second internal surface and a second external surface, an internal cavity 730 between said first and second sides and at least one opening, 740 such that said internal cavity is externally accessible by the user's hand. A cleaning mitt suitable to remove particles such as lint or hair can be made by securing strips 750 of base material comprising protrusions to a mitt or by forming a mitt with the previously described cleaning sheets. A user can simply insert his hand in the mitt and use it to clean a soft surface. Since the substrate used to make the mitt can be substantially non-rigid, a user can use his hand to adopt the contours of the surface to be cleaned. Once the cleaning side(s) of the mitt is(are) saturated, the user can simply dispose of the mitt.

As already previously described, a mitt can comprise a single opening but a mitt can also comprise two opening. This may be the case for example when the substrate comprising the protrusions is formed into a sleeve. One skilled in the art will understand that such a sleeve comprising protrusions might be suitable for hand use but that it might also be used with a cleaning implement having a mop head. Such a sleeve can be sized such that it can be “threaded” on at least a portion of a mop head. In one embodiment, two sleeves comprising protrusions are threaded on each side of a mop head relative the handle of a cleaning implement.

In another embodiment, the sleeve can be attached to the mop head of the implement by a clip fitting over top of the sleeve, or by any other system suitable for fastening the sleeve to the implement, such as for example, hook and loop fasteners, grippers, or adhesive.

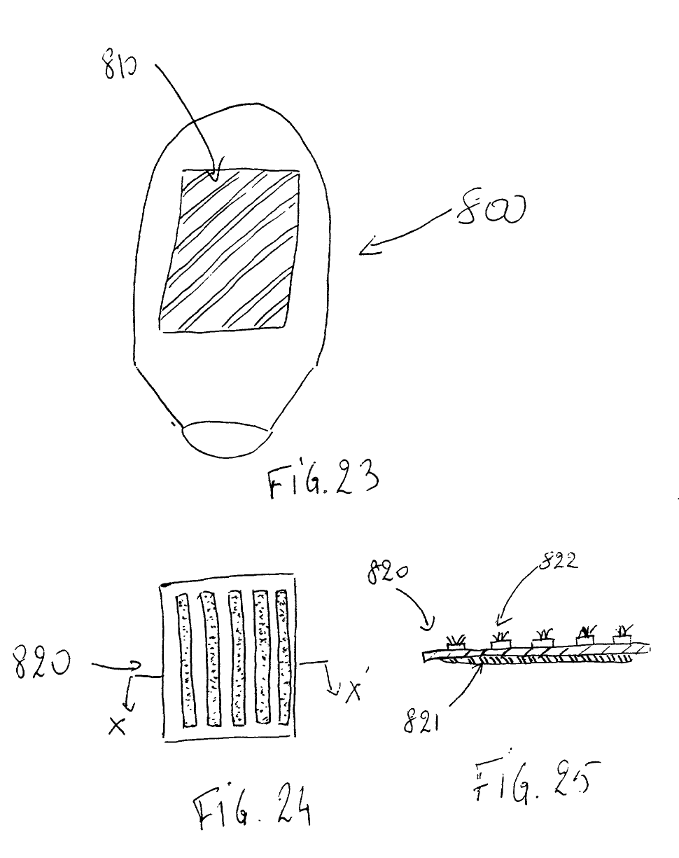

In another embodiment, another type of cleaning implement can be a mitt or glove which is made of a substantially non-rigid material such as for example, a fabric made of any type of natural or synthetic fibers, leather, plastic or any suitable material. This mitt/glove 800 comprises on at least one side an area having fastening material 810 such as hooks or loops fasteners or an additive material such as a pressure sensitive adhesive. This area of hooks or loops fasteners on the mitt or glove, can be used to secure a cleaning sheet 820, as schematically shown in FIG. 24 and 25, having on one side respectively a fastening material 821, which can be loops or hooks fasteners, and on the other side hooks-type protrusions 822 as previously described. In another embodiment, a disposable cleaning sheet may also comprise an adhesive on one side and hook-type protrusions on the other. In this embodiment, the adhesive can be used to fasten the disposable cleaning sheet to a reusable mitt or glove. In this embodiment, the user can removably attach a disposable cleaning sheet to the mitt or glove and throw this cleaning sheet away after use. This embodiment presents the advantage that the mitt or glove is reusable and only the disposable cleaning sheet needs to be replaced. In a preferred embodiment, the mitt or glove comprises hooks-type fasteners, which can engage the loops of a disposable cleaning sheet as previously described.

### IV. METHODS OF USE

The present invention further relates to methods of using the disposable cleaning sheets of the present invention to remove debris from surfaces, especially soft surfaces, such as carpeting, upholstery, and the like.

The present methods generally comprise the step of contacting a surface with a cleaning sheet of the present invention. The surface is preferably contacted by wiping the surface with the cleaning sheet. The present methods can also comprise the step of disposing of the cleaning sheet containing the debris after use. Many different surfaces can be cleaning with the present cleaning sheets, including carpet, upholstery, and fabrics, which can be found in the household, including the stairs of a house, automobile, and the like.

The present cleaning sheets can be used to clean a variety of surfaces. The surface cleaned with the present cleaning sheets is preferably a fibrous surface, comprising filaments, threads, or mixtures thereof. The filaments or threads can be made of wool, silk, cotton, nylon, polypropylene, polyester, or mixtures thereof. A preferred surface herein is carpet, including woven, cut-and-loop pile, plush, saxony, loop, berber, oriental, braided, sculptured, textured, shag, and combinations thereof. Other preferred surfaces include fabric upholstery, fabric window treatments such as drapes and curtains, clothing, bedspread, quilts, and the like.

When cleaning difficult surfaces such as loop or berber carpeting, a preferred step includes placing a mesh screen over the protrusions of the cleaning sheet. The mesh screen helps to reduce the aggressiveness of the protrusions, while still allowing the protrusions to remove and retain debris from the surface being cleaned. A suitable mesh screen includes a mesh screen used in patio and/or sliding doors.

When the surface being cleaned is carpet, the present methods can comprise the steps of vacuuming the carpet and then contacting the carpet with a cleaning sheet of the present invention. The present cleaning sheets are particularly effective in removing debris that is typically difficult to remove with conventional vacuum cleaners, such as pet hair.

With a cleaning sheet comprising protrusions such that the open ends of the protrusions are predominately angled in a common direction and the open ends or slants are facing in the direction of motion of the sheet, a method to remove debris from a soft surface can be to move the sheet in one direction in order to pick up debris and then to rub it in the opposite direction against, for example, the hand of the user or another surface, thereby remove the debris from the sheet. In one embodiment, a cleaning sheet can comprise protrusions such that when the sheet is attached, for example, to the mop head of a cleaning implement, at least a portion of the sheet covering the side(s) or top portion of the mop head, also comprises protrusions. It is possible to rotate the mop head and use the portion of the sheet having protrusions on the side(s) or top of the mop head to remove debris from vertical surfaces, corners and/or edges.

The present methods can also encompass removing allergens from a surface, or reducing allergens in the air, comprising the step of contacting the surface with a disposable cleaning sheet of the present invention.

In another embodiment, the previously described disposable cleaning sheets or mitts can be contained in a package either separately or with at least one other cleaning sheet or mitt. It might be beneficial to communicate to the user instructions on how to use the cleaning sheet or mitt as well as the benefits provided by the cleaning sheets or mitts. A non-limiting example of a manner to communicate the instructions and/or benefits, is to print these instructions and/or benefits on the package containing the cleaning sheet(s) and/or mitt(s). Non-limiting examples of instructions which can be printed on a package containing the previously described cleaning sheet, are:

i. use a disposable cleaning sheets on surfaces selected from the group consisting of: carpets, upholstery, stairs, rugs, floor mats, bath mats, car upholstery, car carpets, drapes, curtains, clothes, any fabric surface, and combinations thereof;

ii. use a disposable cleaning sheets on surfaces selected from the group consisting of: carpets, upholstery, stairs, rugs, floor mats, bath mats, car upholstery, car carpets, drapes, curtains, clothes, any fabric surface, and combinations thereof, to easily capture hair, dust, and other debris;

iii. safe to use a disposable cleaning sheets on surfaces selected from the group consisting of: carpets, upholstery, stairs, rugs, floor mats, bath mats, car upholstery, car carpets, drapes, curtains, clothes, any fabric surface, and combinations thereof;

iv. for use on upholstery or stairs, use a disposable cleaning sheet by hand;

v. for use on upholstery or stairs, use a cleaning sheet attached to an implement with the handle removed from said implement;

vi. for best results, move the implement with the attached disposable cleaning sheet in raking motion, pulling sweeper towards user

vii. for best results, move the implement with the attached disposable cleaning sheet across surface in a back and forth motion

viii. if hair or other debris builds up on the disposable cleaning sheet, pull off and remove excess hair or debris, then continue to use the disposable cleaning cloth;

ix. when task is complete, dispose in trash receptacle the disposable cleaning cloth

x. when the disposable cleaning sheet is full of debris, dispose in a trash receptacle;

xi. when raking sound is no longer audible, the cleaning sheet is full;

xii. when protrusions cannot be felt, the cleaning sheet is full

xiii. when there is no longer any resistance between the cleaning sheet and the surface, the sheet is full; and

xiv. combinations thereof;

In addition or in the alternative, the disposable cleaning sheet can be described as disposable cloths, disposable clothes with descriptors of protrusions selected from the group consisting of: teeth, microbrushes, microbristles, microfingers, micrograspers, and microcombs.

One skilled in the art will understand that the above instructions do not have to be printed and can also be communicated to the user by any other suitable way such as audio communication, visual communication (including TV commercials, animated demonstrations other the internet, live display and public demonstration). One skilled in the art will also understand that some of foregoing instructions can also be communicated to the user for a cleaning mitt.

### EXAMPLE I

An example of a cleaning sheet of the present invention, as shown in FIGS. 1 and 2, is produced as follows. First, two nonwoven, hydroentangled substrates having a basis weight of 65 g/m2 and having dimensions of 20 cm×28 cm are adhered together using a two-sided medical adhesive tape (3M Transfer Adhesive #1524) as follows. The first nonwoven, hydroentangled substrate is laid on a flat surface and then the first side of the two-sided tape is adhered to the entire surface of the first nonwoven substrate. The second nonwoven substrate is then adhered to the second side of the two-sided tape to form a laminate substrate. The laminate substrate is then rolled with a 1 to 2 inch diameter roller to ensure good contact and bonding between each nonwoven substrate and the two-sided tape, trimming the edges if necessary.

Next, two strips of hook material (VELCRO® #088), which have an adhesive backing, are provided having a dimension of 1.25 to 3.8 cm in width and 17 to 20 cm in length. The two strips (i.e. zones) of hook material are positioned near the center of the laminate sheet as shown in FIG. 1, with the distance between them being from 1.25 to 3.8 cm apart, such that the ends of the strips of hook material are between 1.25 to 1.9 cm from the perimeter edges of the laminate substrate. The laminate sheet is again rolled using the roller to provide adequate and even pressure to help in affixing the two strips of hook material to the laminate sheet.

Optionally, the perimeter of the laminate sheet and the perimeter of each of the two strips of hook material are heat sealed using an impulse bag sealer to insure additional bonding.

### EXAMPLE II

An alternative embodiment of the cleaning sheet of the present invention is similar to the cleaning sheet of Example I, except the second nonwoven substrate has two cut-out areas, almost equal in dimension to the two strips of hook material, such that the hook material shows through two cut-out areas of the additional nonwoven substrate, when it is adhered to the first nonwoven substrate to form a laminate substrate. This cleaning sheet is produced as follows. The first nonwoven substrate is laid on a flat surface and the two strips of hook material are positioned on the first nonwoven substrate as shown in FIGS. 1 and 2, and as described in Example I.

In a preferred embodiment, an additional nonwoven substrate is adhered to the second nonwoven substrate of the laminate substrate by first adhering the first side of a piece of two-sided tape to the second substrate of the laminate substrate and then adhering the additional nonwoven substrate to the second side of the two-sided tape. The additional nonwoven substrate has two cut-out areas, almost equal in dimension to the strip hook material, such that the hook material shows through two cut-out areas of the additional nonwoven substrate, when it is adhered to the second nonwoven substrate of the laminate substrate. The cut-out areas have a dimension that is about one-eighth to one-quarter an inch smaller in width and length than the hook dimensions to allow. Again, two-sided adhesive tape is used around the perimeter of the cut-out on the underneath side of this window sheet as well as along the perimeter of the sheet to hold it to the sheet with the hooks. Normally when the window design is used, then only one layer of substrate is used on the bottom sheet to attach the hook material to, so that if a window or non-window design is used, the substrate consists of only two substrate layers and the hook-shaped protrusions.

### EXAMPLE III

An alternative embodiment of the cleaning sheet of the present invention, as shown in FIGS. 3 and 4, begins with a cleaning sheet as described in Example II, wherein the hook material is between the two layers of substrate and shows through the cut-out areas.

Using a short, unidirectional, J-type hook material, the cleaning sheet is assembled so that for each strip of hook material the engagement ends of the hooks are facing the same direction. Clear household silicone adhesive caulk is applied directly to the hook material in 1.3 cm squares, such that they alternate in rows between 1.3 cm squares of exposed hook material, similar to the squares of a checkerboard. See FIGS. 3 and 4. After every 5 squares are applied, the silicone is blotted (with a paper towel) so that it completely fills the space between the apex and the base of the hooks, and slightly covers the apex of the hooks. Only small amounts of silicone are used so that the squares don't spread out when blotting. Both strips of hook material are covered with this checkerboard pattern of clear household silicone caulk. The sheet is placed in a fume hood and the silicone is completely cured.

Optionally, before use, the hooks can be conditioned to glide more smoothly over looped carpeting and other difficult surfaces. This is achieved by placing the cleaning sheet on a cleaning implement and making several passes over clean cut-pile carpeting first, and then over clean berber carpeting.

### EXAMPLE IV

An alternative embodiment of the cleaning sheet of the present invention is shown in FIGS. 5 and 6, wherein hook-shaped protrusions are applied directly, using adhesive material, to a spunbonded substrate having a basis weight of 70 g/m² and comprising 80% of polypropylene fibers and 20% of rayon fibers.

The hook-shaped protrusions of this Example include two different types of hooks, Prong-type hooks, similar to that of FIG. 8, and Mushroom-type hooks, similar to that of FIG. 9. The hook material in this example is first cut into strips of 20 cm length and attached to 4 cm width carpet tape, such that three strips of hook material having 4 rows of hook-shaped protrusions each and 0.9 cm wide, are laid down in parallel lines, with 0.9 cm between the edge of the carpet tape and the first strip, and 0.5 cm between strips. The first two strips consist of long, less aggressive prongs, and the third strip consists of a hook material that has alternating weak prongs and aggressive hinged hooks. The hooks of all three strips are facing the same direction. This is repeated for a second piece of 4 cm width carpet tape. These two strips of tape with hooks attached are placed side by side, with no space between them, in the center of the substrate parallel to the 20 cm sides of the sheet. All of the hooks on both strips of carpet tape are facing the same direction. A strip of 1.25 cm width 3M transfer adhesive is placed along the edge of the carpet tape on one side, parallel to the rows of hooks, so that the hooks are facing away from it. The entire sheet is rolled to provide adequate adhesion to the laminate substrate. The backing is then removed from the 3M adhesive.

Optionally, before use, the hooks can be conditioned to glide more smoothly over looped carpeting and other difficult surfaces. This is achieved by placing the cleaning sheet on a cleaning implement and making several passes over clean cut-pile carpeting first, and then over clean berber carpeting.

### EXAMPLE V

An alternative embodiment of the cleaning sheet of the present invention has strips of hook material attached to the center of an 20 cm×28 cm piece of 70 gsm basis weight spunbond substrate. The strips of hook material consist of 8 rows of long, slightly curved prongs which all lean in the same direction. Two and a half strips of hook material, having a total of 20 rows of hooks, are used on one 4 cm width piece of carpet tape. Each strip is applied so that all the prongs are facing the same direction. Two pieces of carpet tape containing 20 rows of hooks each are placed in the center of the substrate, parallel to the 20 cm sides, 1.25 cm apart. The hooks of both carpet tape strips are facing the same direction. The hooks are then rolled to provide adequate adhesion of the tape to the substrate and the hook material.

Optionally, before use, the hooks can be conditioned to glide more smoothly over looped carpeting and other difficult surfaces. This is achieved by placing the cleaning sheet on a cleaning implement and making several passes over clean cut-pile carpeting first, and then over clean berber carpeting.

### EXAMPLES VI-XII

The following Examples VI-XII illustrate preferred hook-shaped protrusions suitable for the present disposable cleaning sheets. Measurement of the parameters of the exemplified hooks are carried out as follows.

Hook parameter measurements are taken from scanning electron microscope images produced by an Aspex Instruments PSEM 2000 scanning electron microscope (SEM). The hook material is placed on a platform that is cut at a 45° angle to the electron beam. The platform is then tilted 45° so that the image is taken at a 90° angle to the plane of the hook material. Appropriate adjustments to the image quality are made using the Personal SEM Console (version 1.3) software. Measurements in micrometers are made using the “Ruler” function of the computer software, and are then converted to millimeters. Angle measurements are made using a protractor on the magnified photographs taken with the SEM.

| | EXAMPLES VI-XII | | | | | | |
|---|---|---|---|---|---|---|---|
| | VI | VII | VIII | IX | X | XI | XII |
| Hook Type | Mushroom | Mushroom | Prong | Banana | J-Type | Cut-loop | Cut-loop |
| Height, mm | 1.28 | 1.04 | 1.72 | 1.86 | 0.76 | 1.65 | 3.24 |
| Slope, degree | 77 | 74 | 76 | 90 | 87 | 80 | 85 |
| Curl, degree | 140-144 | 130 | 82 | 126 | 161 | 139 | 55 |
| Width at ⅔ height, | 0.23 | 0.50 | 0.16 | 0.26 | 0.16 | 0.25 | 0.21 |
| mm | | | | | | | |
| Width at ⅓ height, | 0.37 | 0.60 | 0.35 | 0.29 | 0.23 | 0.27 | 0.19 |
| mm | | | | | | | |
| Tip diameter, mm | 0.10 | 0.13 | 0.07 | 0.04 | 0.04 | 0.30 | 0.18 |
| Vertical hook gap, | 0.95 | 0.65 | — | 1.18-1.28 | 1.36 | 1.10 | — |
| mm | | | | | | | |
| Horizontal hook | 0.15-0.18 | 0.18 | — | 0.15 | 0.30 | 0.73 | — |
| opening, mm | | | | | | | |
| Vertical Hook | 0.13-0.19 | 0.10 | — | 0.12 | 0.35 | 1.24 | — |
| Opening, mm | | | | | | | |

### EXAMPLE VIII

An alternative embodiment of the cleaning sheet of the present invention is produced as follows. In this embodiment, a tape of protrusions of about 10 mm wide is used. This tape comprises alternating prongs consisting of 4 rows of prongs, with the two outermost rows facing outward in opposite directions, while the two inner rows are facing each other (FIG. 20) This tape of alternating prongs is cut into seven strips of about 21.6 cm each. The strips are dipped in a solution containing 0.055% Laponite B (2% active), a nanoparticle clay, 0.084% Tergitol Min-Foam surfactant (mixed EO/PO alkoxylate of secondary alcohol, 10% active), and 96.4% UV treated DI water for between about 5-10 minutes. Then, these strips of prongs are let dry completely before being used at ambient conditions from about 3 hours to overnight. Using 5.08 cm wide double-sided Manco brand indoor/outdoor carpet tape (model #IO-2), place the first strip of prongs along the long edge of the adhesive tape. Place a second strip of prongs half way on and half way off the other long edge of the tape. Place two strips evenly between these for a total of four strips across this first piece of adhesive tape. Next, take a new piece of about 5.08 cm wide adhesive tape and adjoin the two pieces of adhesive tape using the strip of material that is half way on the first piece such that it is also half way on a long edge of the second adhesive tape. Now the total tape width should be about four inches. Place the remaining three strips of material evenly across the second piece of tape so that the last one is placed right along the edge of the second adhesive tape. Next, cut the side edges down to about 20.3 cm long by cutting a little off along each side edges. The total area should be about 20.3 cm×10.2 cm. Then, cut a substantially rectangular piece of SMS substrate material of about 27.9 cm long and about 20.3 cm wide. The SMS substrate used in this example is a 3 layered having two outer spunbond layers and an inner meltblown layer, and has a basis weight of about 47.5 gsm. One suitable SMS substrate is manufactured by Aspen Technology Company. Remove the tape backing from the double-sided carpet adhesive tape which has the strips of prongs and place the tape in the center of the piece of substrate so that the 20.3 cm length of the tape goes across the 20.3 cm width of the substrate. The entire sheet is rolled to provide adequate adhesion to the laminate substrate.

Optionally, spray the completed sheet evenly with an 8% diluted dispersion of polyacrylate adhesive, Robond PS75R (Rohm & Haas) containing 15% Robond (52.5% active), 42.5% DI water, and 42.5% isopropanol. Make six quick passes evenly over the sheet and let it dry. Spray the sheet two more times in the same way, allowing the sheet to dry for at least about one hour in between sprays. After the final spray, let the sheet dry overnight before using. The final adhesive weight on the sheets is about 0.45 to about 0.55 gsm.

What is claimed is:

1. A disposable cleaning sheet for removing debris from a surface, said cleaning sheet comprising:
(a) a substrate; and
(b) a plurality of protrusions affixed to said substrate;
wherein said cleaning sheet is removably attachable to a cleaning implement.

2. The disposable cleaning sheet of claim 1 wherein said protrusions are affixed to said substrate in one or more discrete zone(s) and said zone(s) of protrusions cover at least about 5% to about 100% of a surface of said substrate and said zone(s) comprises from about 1 to about 1000 protrusions per square cm; wherein the balance of said substrate is substantially free of protrusions; and wherein the distance between individual protrusions in said zone(s) is from about 0.2 to about 10 mm.

3. The disposable cleaning sheet of claim 1 wherein said substrate is attached to said cleaning implement via a hook-and-loop fastener system; and wherein either: (a) said substrate comprises hooks which are releasably fastened to complementary loops which are affixed to said cleaning implement, or (b) said substrate comprises loops which are releasably fastened to complementary hooks which are affixed to said cleaning implement.

4. The disposable cleaning sheet of claim 3 wherein said hooks or loops are arranged along the edges of said substrate and wherein said complementary loops or hooks are attached to the top or side surfaces of said cleaning implement.

5. The disposable cleaning sheet of claim 1 wherein said substrate is attached to said cleaning implement by inserting edges of said substrate into grippers located on a mop head of said cleaning implement.

6. The disposable cleaning sheet of claim 1 wherein edges of said substrate used for attaching said substrate to said cleaning implement are substantially free of protrusions.

7. The disposable cleaning sheet of claim 6 wherein said edges of said substrate comprise a pressure sensitive adhesive; wherein said pressure sensitive adhesive forms a temporary attachment between said substrate and said cleaning implement.

8. The disposable cleaning sheet of claim 1 wherein at least some of said protrusions have:
(a) a Total Height of from about 0.05 mm to about 80 mm;
(b) a Stem Width at ⅓ Height of from about 0.002 to about 5 mm; or
(c) a ratio of Vertical Hook Opening to Total Height of from about 1:20 to about 1:1.

9. The disposable cleaning sheet of claim 1 wherein said protrusions comprise a thermoplastic resin having a softening temperature of from about 45° C. to about 260° C.

10. The disposable cleaning sheet of claim 9, wherein said thermoplastic resin has adhesive properties at ambient temperature.

11. The disposable cleaning sheet of claim 1 wherein an additive material is affixed to said substrate and/or said protrusions; wherein said additive material is a pressure sensitive adhesive.

12. The disposable cleaning sheet of claim 1 wherein said surface is carpet.

13. The disposable cleaning sheet of claim 8 wherein said protrusions comprise at least two types of protrusions affixed to said substrate; wherein said types of protrusions differ in Total Height, Stem Width at ⅓ Height, ratio of Vertical Hook Opening to Total Height, Curl, or Tip Diameter.

14. The disposable cleaning sheet of claim 13 wherein said types of protrusions comprise primary protrusions and secondary protrusions; wherein a ratio of Total Height of said primary protrusions to Total Height of said secondary protrusions is from about 1:1 to about 10:1.

15. The disposable sheet of claim 14 wherein said primary protrusions are hook-shaped and are selected from the group consisting of: Prong-type hooks, Banana-type hooks, Y-type hooks and combinations thereof; and wherein said secondary protrusions are hook-shaped and are selected from the group consisting of: J-type hooks, Mushroom-type hooks, Banana-type hooks, Y-type hooks, Multi-tipped type hooks and combinations thereof.

16. The disposable cleaning sheet of claim 14 wherein said substrate comprises rows of said primary protrusions, alternating rows of said primary protrusions and said secondary protrusions, or combinations thereof.

17. The disposable cleaning sheet of claim 14 wherein said primary protrusions and said secondary protrusions comprise thermoplastic resin; wherein said primary protrusions are comprised of a thermoplastic resin having a lower Young's modulus than said thermoplastic resin comprising said secondary protrusions.

18. The disposable cleaning sheet of claim 8 wherein said protrusions have a Slope of from about 15° to about 90°.

19. The disposable cleaning sheet of claim 8 wherein said protrusions have: a Slope of from about 40° to about 90°; a Tip Diameter of from about 0.01 to about 1.0 mm; a Curl of form about 1° to about 180°; a ratio of Stem Width at ⅔ Height to Stem Width at ⅓ Height of from about 1:2 to about 0.95:1; or a Length of from about 0.01 to about 10 mm.

20. The disposable cleaning sheet of claim 8 wherein said protrusions comprise at least two engagement ends; wherein said engagement ends point in at least two different directions.

21. The disposable cleaning sheet of claim 8 wherein said protrusions comprise from 1 to 10 engagement ends arranged laterally along the stems of said protrusions.

22. The disposable cleaning sheet of claim 8 wherein at least some of said protrusions are covered by an additive material comprising a polymeric resin; and wherein said polymeric resin is cured or dried to form solid platforms; and wherein a ratio of the height of said platforms to the Total Height of said protrusions is from about 4:5 to 2:1.

23. The disposable cleaning sheet of claim 22 wherein regions of said platforms and regions of said protrusions form a geometric pattern, and wherein size of each platform is from about 0.25 to about 25 square cm.

24. The disposable cleaning sheet of claim 8 wherein said protrusions comprise a thermoplastic resin having a Young's modulus of from about 0.0001 to about 0.15 kN/m².

25. The disposable cleaning sheet of claim 24, wherein said thermoplastic resin comprises a thermoplastic polymer selected from the group consisting of: styrene copolymer blends, wherein the copolymer is selected from the group consisting of butadiene, acrylonitrile, divinylbenzene, maleic anhydride; block copolymers containing polystyrene endblocks and polyisoprene, polybutadiene, and/or polyethylene-butylene midblocks; polyolefins such as polyethylene, polypropylene, amorphous polypropylene, polyisoprene, and polyethylene propylene; ethylene-vinylacetate copolymers; acrylonitrile-butadiene copolymers; polyesters such as polyethylene terphthalate; polyamides such as Nylon 6 and Nylon 11; polyisobutylene; poly(vinyl ethylene-co-1,4-butadiene); natural rubber [poly cis-isoprene]; polyacrylic acid and salts thereof; polymethacrylic acid and salts thereof; polydimethylsiloxane; polydiphenylsiloxane; poly methyl phenyl siloxane; polyvinyl alcohol; polyvinyl chloride; polyvinylidene chloride; polyurethane; and mixtures thereof.

26. The disposable cleaning sheet of claim 25 wherein said thermoplastic resin is selected form the group consisting of polypropylene and polyethylene.

27. The cleaning sheet of claim 8 wherein said substrate further comprises an additive material, wherein said additive material is a pressure sensitive adhesive applied to either said substrate, said protrusions, or combinations thereof.

28. The cleaning sheet of claim 27 wherein said pressure sensitive adhesive has an adhesive characteristic selected from the group consisting of:
(a) a Tack Value of from about 100 to about 500;
(b) a Cohesive/Adhesive Ratio of from about 0.2 to about 20;
(c) a Stringiness Value of from about 2.5 to about 12.0; and
(d) combinations thereof.

29. The disposable cleaning sheet of claim 8 wherein said substrate is selected from the group consisting of polymeric films, polymeric nonwovens, cellulosics, and paper.

30. The disposable cleaning sheet of claim 8 wherein said substrate is selected from the group consisting of: spunbonded nonwoven substrate, meltblown nonwoven substrate, and combinations thereof.

31. The disposable cleaning sheet of claim 8 wherein said substrate is a hydroentangled nonwoven substrate.

32. The disposable cleaning sheet of claim 8 wherein said protrusions are printed directly on said substrate via a screen printing process or a modified gravure printing process.

33. The disposable cleaning sheet of claim 32 wherein said substrate has a softening temperature no greater than 30° C. higher than a softening temperature of said thermoplastic resin of said protrusions.

34. The disposable cleaning sheet of claim 8 wherein said protrusions are formed via an extrusion process or a cut-loop formation process, wherein said protrusions are attached to one or more layers of additional substrate to form said cleaning sheet, wherein said additional substrate is selected for the group consisting of: polymeric films, polymeric nonwovens, cellulosics, and paper; and wherein said protrusions are either the top layer, or said additional substrate with windows cut out to expose said protrusions is the top layer.

35. The disposable cleaning sheet of claim 8 wherein said sheet further comprises an additive material selected from the group consisting of: perfumes, pest control ingredients, antimicrobials, and mixtures thereof.

36. A method of removing debris from a surface, said method comprising the step of contacting said surface with a disposable cleaning according to claim 1.

37. The method of claim 36, wherein the surface is selected from the group consisting of: carpets, rugs, upholstery, fabrics, and mixtures thereof.

38. The method of claim 36 wherein said surface comprises pet hair.

39. The method of claim 36 wherein the open end of said hooks or protrusions are oriented predominately in a common direction, with the open ends or the slants of said protrusions are facing in the direction of motion of the sheet when picking up debris.

40. The method of claim 36 wherein said sheet is moved in a single direction and wherein said single direction to pick up debris is to pull the sheet towards the user.

41. The method of claim 36 wherein the cleaning sheet is moved in both a forward and backward motion to pick up debris.

42. The method of claim 41 wherein said cleaning sheet has hooks opening or protrusions slanted in at least two opposing directions.

43. The method of claim 36 wherein said debris comprises particulates, and said cleaning sheet comprises an adhesive material to hold said particulates to said cleaning sheet.

44. The method of claim 36 wherein said method is also effective at reducing allergens in the air.

45. The method of claim 36 wherein said method further comprises the step of providing a user of said cleaning sheet with instructions selected from the group consisting of:
i. use said disposable cleaning sheets on surfaces selected from the group consisting of: carpets, upholstery, stairs, rugs, floor mats, bath mats, car upholstery, car carpets, drapes, curtains, clothes, any fabric surface, and combinations thereof;
ii. use said disposable cleaning sheets on surfaces selected from the group consisting of: carpets, upholstery, stairs, rugs, floor mats, bath mats, car upholstery, car carpets, drapes, curtains, clothes, any fabric surface, and combinations thereof, to easily capture hair, dust, and other debris;
iii. safe to use said disposable cleaning sheets on surfaces selected from the group consisting of: carpets, upholstery, stairs, rugs, floor mats, bath mats, car upholstery, car carpets, drapes, curtains, clothes, any fabric surface, and combinations thereof;
iv. for use on upholstery or stairs, use said disposable cleaning sheet by hand;
v. for use on upholstery or stairs, use said cleaning sheet attached to said implement with the handle removed from said implement;
vi. for best results, move said implement with said attached disposable cleaning sheet in raking motion, pulling sweeper towards user;
vii. for best results, move said implement with said attached disposable cleaning sheet across surface in a back and forth motion;
viii. if hair or other debris builds up on said disposable cleaning sheet, pull off and remove excess hair or debris, then continue to use said disposable cleaning cloth;
ix. when task is complete, dispose in trash receptacle said disposable cleaning cloth;
x. when said disposable cleaning sheet is full of debris, dispose in a trash receptacle;
xi. when raking sound is no longer audible, the cleaning sheet is full;
xii. when protrusions can't be felt, the cleaning sheet is full;
xiii. when there is no longer any resistance between the sheet and the surface, the sheet is full; and
xiv. combinations thereof;
wherein said disposable cleaning sheet are alternatively described as disposable cloths, disposable clothes with descriptors of protrusions selected from the group consisting of: teeth, microbrushes, microbristles, microfingers, micrograspers, and microcombs.

46. The method of claim 45 wherein said instructions are printed as part of a package comprising said disposable cleaning sheets.

47. A method of removing debris from a surface, said method comprising the step of contacting said surface with a disposable cleaning sheet according to claim 8, and wherein said cleaning sheet is used by hand, without using a cleaning implement.

48. A method of removing debris left by vacuum cleaners, comprising the steps of vacuuming an area and then contacting said surface with a disposable cleaning sheet according to claim 1.

49. A disposable cleaning sheet for removing debris from a surface, said cleaning sheet comprising:
(a) a substrate; and
(b) at least one strip of material attached to said substrate wherein said strip comprises a plurality of protrusions.

50. The disposable cleaning sheet of claim 49 wherein said protrusions have a base, at least one stem and at least one engagement end.

51. The disposable cleaning sheet of claim 50 wherein said protrusions are hooks selected from the group consisting of J-type protrusion, Prong-type protrusion, Banana-type protrusion, Mushroom-type protrusion, Y-type protrusion, Multi-tipped protrusion and any combinations thereof.

52. The disposable cleaning sheet of claim 50 wherein at least some of said engagement ends are pointing towards different directions.

53. The disposable cleaning sheet of claim 49 said aligned are aligned to form a row of protrusions.

54. The disposable cleaning sheet of claim 53 wherein said at least one strip of material comprises 4 rows of protrusions.

55. The disposable cleaning sheet of claim 54 wherein the engagement ends of the protrusions of at least one of said rows are pointing towards a first direction and the engagement ends of the protrusions of the remaining rows are pointing towards a second direction.

56. The disposable cleaning sheet of claim 55 wherein said first and said second direction are opposite directions.

57. The disposable cleaning sheet of claim 56 wherein the engagement ends of the protrusions of two consecutive rows are pointing towards opposite directions.

58. The disposable cleaning sheet of claim 49 wherein said cleaning sheet further comprises an additive material.

59. The disposable cleaning sheet of claim 58 wherein said additive material is a polymeric additive having adhesive properties at ambient temperature.

60. The disposable cleaning sheet of claim 49 wherein said disposable cleaning sheet is removably attachable to a cleaning implement.

61. A disposable cleaning mitt for removing debris from a surface comprising:
(a) a first side having a first internal surface and a first external surface;
(b) a second side having a second internal surface and a second external surface;
(c) an internal cavity between said first and second sides;
(d) at least one opening, such that said internal cavity is externally accessible; and
(e) a plurality of protrusions affixed to said first external surface and/or said second external surface.

62. A disposable cleaning mitt for removing debris from a surface comprising:
(a) a first side having a first internal surface and a first external surface;
(b) a second side having a second internal surface and a second external surface;
(c) an internal cavity between said first and second sides;
(d) at least one opening, such that said internal cavity is externally accessible; and
(e) at least one strip of material attached to said first external surface and/or said second external surface wherein said strip comprises a plurality of protrusions.

63. A kit for removing debris from a surface, said kit comprising:
(a) a reusable mitt comprising:
(i) a first side having a first internal surface and a first external surface;
(ii) a second side having a second internal surface and a second external surface;
(iii) an internal cavity between said first and second sides;
(iv) at least one opening, such that said internal cavity is externally accessible;
(v) hook fasteners affixed to said first external surface and/or said second external surface; and
(b) a disposable cleaning sheet comprising:
a substrate having a first surface and a second surface, wherein at least a portion of said first surface comprises a material for removably engaging said hook fasteners, and wherein said second surface of said cleaning sheet comprises a plurality of protrusions affixed to said substrate.

64. A disposable cleaning sheet for use with a cleaning device having hook or loop fasteners, said cleaning sheet comprising:
a substrate having a first surface and a second surface, wherein at least a portion of said first surface comprises a material for removably engaging said hook or loop fasteners of said cleaning device, and wherein said second surface of said cleaning sheet comprises a plurality of protrusions affixed to said substrate.

65. The disposable cleaning sheet of claim 64 wherein said cleaning device is a cleaning implement.

66. The disposable cleaning sheet of claim 64 wherein said cleaning device is a reusable cleaning mitt.

67. A kit for removing debris from a surface, said kit comprising:
(a) a reusable mitt comprising:
(i) a first side having a first internal surface and a first external surface;
(ii) a second side having a second internal surface and a second external surface;
(iii) an internal cavity between said first and second sides;
(iv) at least one opening, such that said internal cavity is externally accessible;
(b) a disposable cleaning sheet comprising:
a substrate having a first side and a second side, wherein at least a portion of said first side comprises a polymeric additive having adhesive properties at ambient temperature for removably engaging said first and/or second external side of said mitt, wherein said second side of said cleaning sheet comprises a plurality of protrusions affixed to said substrate.
